(19) United States
(12) Patent Application Publication
(10) Pub. No.: US 2016/0373804 A1
(43) Pub. Date: Dec. 22, 2016

(54) SYSTEMS AND METHODS OF DISPLAYING AND NAVIGATING CONTENT BASED ON DYNAMIC ICON MAPPING

(71) Applicant: OpenTV, Inc., San Francisco, CA (US)

(72) Inventor: Nandini Iyer, Fremont, CA (US)

(21) Appl. No.: 14/741,685

(22) Filed: Jun. 17, 2015

(51) Int. Cl. H04N 21/431; H04N 21/25; H04N 21/466; H04N 21/45; H04N 21/258

(52) U.S. Cl. CPC H04N 21/4312; H04N 21/4532; H04N 21/25891; H04N 21/4667; H04N 21/251

(57) ABSTRACT

A device for enabling actions associated with items of content to occur is configured to present icons representing items of content based at least in part on user preference information. User preference information may include a list of favorite channels. User preference information may be based at least in part on a recognized pattern of user behavior. The device may be configured to present action icons associated actions available for items of content actions. The device may enable a user to cause actions associated with an action icon to be performed by executing an action drag and drop activation.

### TECHNICAL FIELD

The present disclosure relates to the field of interactive television and graphical user interfaces.

### BACKGROUND

Digital media playback capabilities may be incorporated into a wide range of devices, including digital televisions, including so-called “smart” televisions, set-top boxes, laptop or desktop computers, tablet computers, e-book readers, digital recording devices, digital media players, video gaming devices, digital cameras, cellular phones, including so-called “smart” phones, and dedicated video streaming devices. Digital media content may originate from a plurality of sources including, for example, over-the-air television providers, satellite television providers, cable television providers, and online media-sharing services, including, online media streaming and downloading services. Further, devices with digital media playback capabilities may provide a user with interfaces, including graphical user interfaces (GUIs), that enable the user to select an item of content.

Due to the wide range of content users may access on devices with digital media playback capabilities, traditional interfaces and current techniques for organizing, sorting, and displaying available items of content may be less than ideal.

### SUMMARY

The following brief summary is not intended to include all features and aspects of the present invention, nor does it imply that the invention must include all features and aspects discussed in this summary. The present disclosure relates to the field of user interfaces and more specifically describes techniques and tools for enabling a user to navigate and display items of content. It should be noted that as used herein the term item of content may include individual items of digital content (e.g., video files, music files, and digital images), collections of individual items of digital content (e.g., a collection of video files, an album including music files, and an album of digital images), and/or sources of digital content (e.g., a television channel accessible through a tuner, and a media streaming service). Further, the term item of content may refer to an application (e.g., an application enabling a user to access a social media service). The present disclosure provides techniques for dynamically presenting icons representing items of content and further provides techniques for enabling a user select items of content. In some examples, icons representing items of content may be associated with multiple types of actions. That is, for example, a user may cause one of a plurality of actions associated with an item of content to be performed based on how a user interacts with an icon. In some examples, the techniques described herein may be implemented in a device with digital media playback capabilities, including, for example, set-top boxes, televisions, laptop or desktop computers, gaming consoles, dedicated streaming devices, and an associated companion device, including, for example, remote controllers, tablet computers, and smart phones. It should be noted that in some instances the techniques described herein may be generally applicable to devices capable of displaying graphical user interfaces.

According to one example of the disclosure, a method of causing actions associated with items of content to occur comprises presenting at least one icon representing an item of content on a user interface of a companion device based at least in part on user preference information, wherein the user interface includes a touchscreen display, determining whether a particular type of icon activation from a set of at least two types of icon activations is performed on one of the icons presented on the user interface, and causing an action associated with an item of content to occur based on a determination that a particular type of activation was performed.

According to another example of the disclosure, a device for causing actions associated with items of content selection to be occur comprises one or more processors configured to present at least one icon representing an item of content on a user interface of a companion device based at least in part on user preference information, wherein the user interface includes a touchscreen display, determine whether a particular type of icon activation from a set of at least two types of icon activations is performed on one of the icons presented on the user interface, and cause an action associated with an item of content to occur based on a determination that a particular type of activation was performed.

According to another example of the disclosure, an apparatus for enabling actions associated with items of content selection to be performed comprises means for presenting at least one icon representing an item of content on a user interface of a companion device based at least in part on user preference information, wherein the user interface includes a touchscreen display, means for determining whether a particular type of icon activation from a set of at least two types of icon activations is performed on one of the icons presented on the user interface, and means for causing an action associated with an item of content to occur based on a determination that a particular type of activation was performed.

According to another example of the disclosure, a non-transitory computer-readable storage medium has instructions stored thereon that upon execution cause one or more processors of a device to present at least one icon representing an item of content on a user interface of a companion device based at least in part on user preference information, wherein the user interface includes a touchscreen display, determine whether a particular type of icon activation from a set of at least two types of icon activations is performed on one of the icons presented on the user interface, and cause an action associated with an item of content to occur based on a determination that a particular type of activation was performed.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is block diagram illustrating an example of a system that may implement one or more techniques of this disclosure.

FIG. 2 is a block diagram illustrating an example of a computing device that may implement one or more techniques of this disclosure.

FIG. 3 is a block diagram illustrating an example of a companion device that may implement one or more techniques of this disclosure.

FIG. 4 is a conceptual diagram illustrating an example of a user interface that may implement one or more techniques of this disclosure.

FIG. 5 is a conceptual diagram illustrating an example of a user interface that may implement one or more techniques of this disclosure.

FIGS. 6A-6B are conceptual diagrams illustrating examples of user interfaces that may implement one or more techniques of this disclosure.

FIGS. 7A-7B are conceptual diagrams illustrating examples of user interfaces that may implement one or more techniques of this disclosure.

FIG. 8 is a flowchart illustrating an example method for enabling selection of content according to one or more of the techniques of this disclosure.

FIG. 9 is a conceptual diagram illustrating an example graphical user interface that may implement one or more techniques of this disclosure.

FIGS. 10A-10B are conceptual diagrams illustrating example user interfaces that may implement one or more techniques of this disclosure.

FIGS. 11A-11B are conceptual diagrams illustrating example user interfaces that may implement one or more techniques of this disclosure.

FIG. 12 is a conceptual diagram illustrating an example graphical user interface that may implement one or more techniques of this disclosure.

### DETAILED DESCRIPTION

Described herein are systems and methods for enabling a user to select items of content. Some embodiments extend to a machine-readable medium embodying instructions which, when executed by a machine, cause the machine to perform any one or more of the methodologies described herein. Other features will be apparent from the accompanying drawings and from the detailed description that follows. Examples merely typify possible variations. Unless explicitly stated otherwise, components and functions are optional and may be combined or subdivided, and operations may vary in sequence or may be combined or subdivided. In the following description, for purposes of explanation, numerous specific details are set forth to provide a thorough understanding of example embodiments. It will be evident to one skilled in the art, however, that the present subject matter may be practiced without these specific details.

Devices with digital media playback capabilities, including, for example, televisions and set-top boxes may include a push-button remote controller. Push-button remote controllers enable a user to select an item of content by activating a sequence of buttons, for example, keying a number associated with a television channel. Further, devices with digital media playback capabilities may be configured to provide users thereof with graphical user interfaces that enable the selection of content. For example, a set-top box may be configured to provide a user with an electronic programming guide (EPG), where the electronic programming guide displays items of content in a grid. That is, an EPG may display items of content in a grid according to television network and time slot. A push-button remote controller may enable a user to select a particular item of content from within a grid for viewing.

Devices with digital media playback capabilities may enable a user to access items of content from diverse sources. For example, a single device with digital media capabilities may enable a user to access digital media from a television service as well as from an online media streaming service, thereby increasing the types and number of items of content available to a user. Further, instead of simply viewing an item of content, a user may wish to perform other actions with respect to an item of content. For example, a user may wish to record an item of content, add an item of content to a watch list for viewing at a later time, endorse an item of content, share an item of content with another user, and/or rate an item of content. Due to the numerous items of content that may be available to a user and the plurality of available actions with respect to an item of content, traditional graphical user interfaces, including traditional EPGs, and traditional push-button remote controllers may be less than ideal.

It should be noted that although some devices with digital media playback capabilities enable a user to select items of content using a companion device (e.g., a secondary computing device) in communication with the device, current techniques for enabling a user to select an item of content using a companion device are less than ideal. The techniques described herein may enable a user to more efficiently perform actions associated with available items of content, including content available from a plurality of diverse sources. As described in detail below, the systems and techniques described herein may dynamically present available items of content to a user and enable a user to perform multiple types of actions with respect to a particular item of content using a companion device.

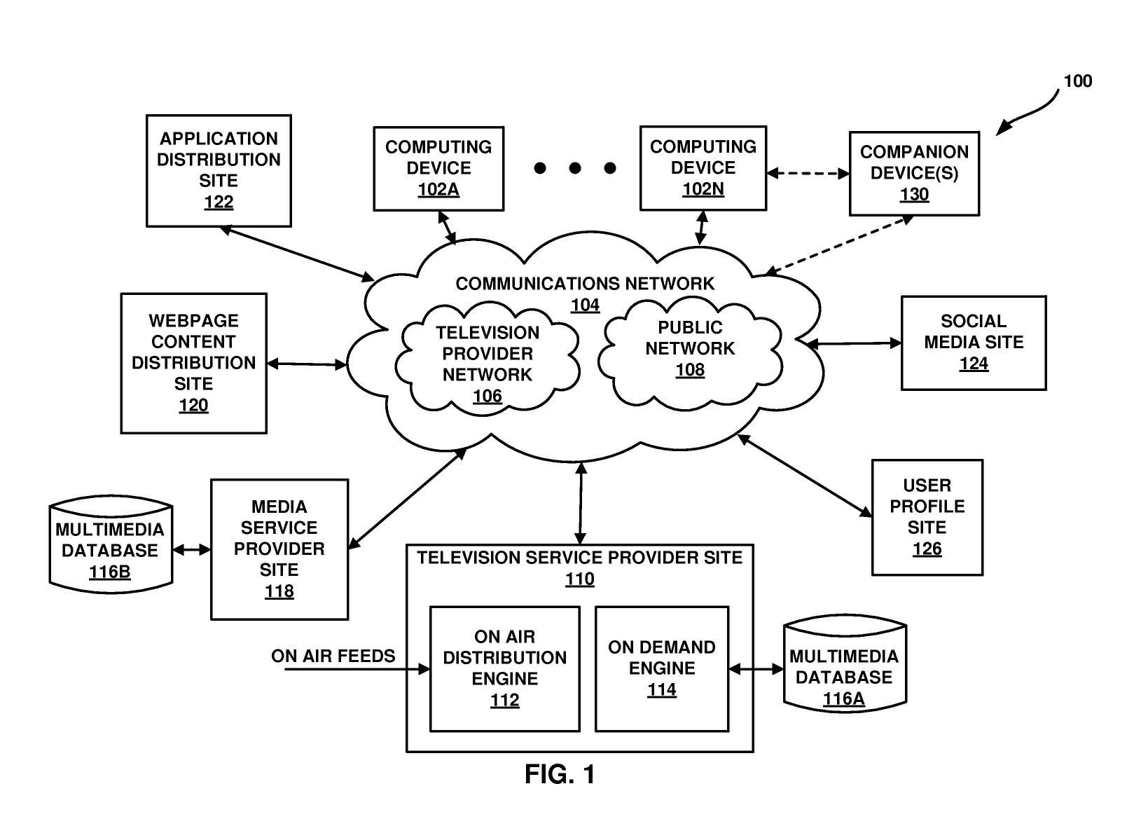

FIG. 1 is block diagram illustrating an example of a system that may implement one or more techniques described in this disclosure. System 100 may be configured to enable content selection in accordance with the techniques described herein. In the example illustrated in FIG. 1, system 100 includes one or more computing devices 102A-102N, communications network 104, television service provider site 110, media service provider site 118, webpage content distribution site 120, application distribution site 122, social media site 124, user profile site 126, and companion device(s) 130. System 100 may include software modules operating on one or more servers. Software modules may be stored in a memory and executed a processor. Servers may include one or more processors and a plurality of internal and/or external memory devices. Examples of memory devices include file servers, FTP servers, network attached storage (NAS) devices, local disk drives, or any other type of device or storage medium capable of storing data. Storage media may include Blu-ray discs, DVDs, CD-ROMs, flash memory, or any other suitable digital storage media. When the techniques described herein are implemented partially in software, a device may store instructions for the software in a suitable, non-transitory computer-readable medium and execute the instructions in hardware using one or more processors.

System 100 represents an example of a system that may be configured to allow digital content, such as, for example, music, videos, images, webpages, messages, voice communications, and applications, to be distributed to and accessed by a plurality of computing devices, such as computing devices 102A-102N. In the example illustrated in FIG. 1, computing devices 102A-102N may include any device configured to transmit data to and/or receive data from communication network 104. For example, computing devices 102A-102N may be equipped for wired and/or wireless communications and may include set-top boxes, digital video recorders, televisions, desktop, laptop, or tablet computers, gaming consoles, mobile devices, including, for example, “smart” phones, cellular telephones, and personal gaming devices. It should be noted that although example system 100 is illustrated as having distinct sites, such an illustration is for descriptive purposes and does not limit system 100 to a particular physical architecture. Functions of system 100 and sites included therein may be realized using any combination of hardware, firmware and/or software implementations.

Communications network 104 may comprise any combination of wireless and/or wired communication media. Communications network 104 may include coaxial cables, fiber optic cables, twisted pair cables, wireless transmitters and receivers, routers, switches, repeaters, base stations, or any other equipment that may be useful to facilitate communications between various devices and sites. Communications network 104 may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and IEEE standards, such as, for example, one or more of standards included in the IEEE 802 family of standards.

As illustrated in FIG. 1, networks of different types may be defined within communications network 104. Networks may be defined according to physical and/or logical aspects. For example, networks that share the same physical infrastructure (e.g., coaxial cables) may be distinguished based on a primary service type (e.g., webpage access or television service) or communications protocols (e.g., IP/TCP or MPEG-TS). In the example illustrated in FIG. 1, communications network 104 includes television provider network 106 and public network 108. It should be noted that although television provider network 106 and public network 108 are illustrated as distinct, television provider network 106 and public network 108 may share physical and/or logical aspects.

Television provider network 106 is an example of a network configured to provide a user with television services. For example, television provider network 106 may include public over-the-air television networks, public or subscription-based satellite television service provider networks, and public or subscription-based cable television provider networks. It should be noted that although in some examples television provider network 106 may primarily be used to provide television services, television provider network 106 may also provide other types of data and services according to any combination of the telecommunication protocols described herein.

Public network 108 is an example of a packet-based network, such as, a local area network, a wide-area network, or a global network, such as the Internet, configured to provide a user with World Wide Web based services. Public network 108 may be configured to operate according to Internet Protocol (IP) standards. It should be noted that although in some examples public network 108 may primarily be used to provide access to hypertext web pages, public network 108 may also provide other types of media content according to any combination of the telecommunication protocol described herein.

Referring again to FIG. 1, television service provider site 110 may be configured to provide computing devices 102A-102N with television service. For example, television service provider site 110 may include a public broadcast station, a cable television provider, or a satellite television provider and may be configured to provide television services to analog and/or digital televisions and set-top boxes. In the example illustrated in FIG. 1, television service provider site 110 includes on air distribution engine 112 and on demand engine 114. On air distribution engine 112 may be configured to receive a plurality of on air feeds and distribute the feeds to computing devices 102A-102N through television provider network 106. For example, on air distribution engine 112 may be configured to receive one or more over-the-air television broadcasts via a satellite uplink/downlink and distribute the over-the-air television broadcasts to one or more users of a subscription-based cable television service.

On demand engine 114 may be configured to access a library of multimedia content and distribute multimedia content to one or more of computing devices 102A-102N through television provider network 106. For example, on demand engine 114 may access multimedia content (e.g., music, movies, and TV shows) stored in multimedia database 116A and provide a subscriber of a cable television service with movies on a Pay Per View (PPV) basis. Multimedia database 116A may be a storage device configured to store multimedia content. It should be noted that multimedia content accessed through on demand engine 114 may also be located at various sites within system 100 (e.g., peer-to-peer distribution).

Media service provider site 118 represents an example of a multimedia service provider. Media service provider site 118 may be configured to access a library of multimedia content and distribute multimedia content to one or more of computing devices 102A-102N through public network 108. For example, media service provider site 118 may access multimedia (e.g., music, movies, and TV shows) stored in multimedia database 116B and provide a user of a media service with multimedia. Multimedia database 116B may be a storage device configured to store multimedia content. In one example, media service provider site 118 may be configured to provide content to one or more of computing devices 102A-102N using the Internet protocol suite. In some examples, a media service may be referred to as a streaming service. Commercial examples of streaming services include Hulu, YouTube, Netflix, Amazon Prime and television network based streaming services (e.g. WatchESPN). As described above, television provider network 106 and public network 108 may share physical and logical aspects. Thus, content accessed by one or more of computing devices 102A-102N through media service provider site 118 may be transmitted through physical components of television provider network 106. For example, a user of one of computing devices 102A-102N may access the Internet and multimedia content provided by a media service through a cable modem connected to a coaxial network maintained by a cable television provider.

Webpage content distribution site 120 represents an example of a webpage service provider. Webpage content distribution site 120 may be configured to provide hypertext based content to one or more of computing devices 102A-102N through public network 108. It should be noted that hypertext based content may include audio and video content. Hypertext content may be defined according to programming languages, such as, for example, Hypertext Markup Language (HTML), Dynamic HTML, and Extensible Markup Language (XML). Examples of webpage content distribution sites include the United States Patent and Trademark Office website.

Application distribution site 122 represents an example of an application distribution service. Application distribution site 122 may be configured to distribute software applications to one or more of computing devices 102A-102N. In one example, software applications may include games and programs operable on computing devices. In other examples, software applications may be configured to allow a computing device to access content provided by a webpage content distribution site in manner specific to the computing device. For example, software applications may be configured to provide enhanced or reduced functionality of a webpage to a mobile device or a set-top box. Software applications may be developed using a specified programming language. Examples of programming languages include, Java™, Jini™, C, C++, Perl, UNIX Shell, Visual Basic, and Visual Basic Script. In some examples, developers may write software applications using a software development kit (SDK) provided by a device manufacturer or a service provider. In the example where one or more of computing devices 102A-102N are mobile devices, application distribution site 122 may be maintained by a mobile device manufacturer, a service provider, and/or a mobile device operating system provider. In the example where one or more of computing devices 102A-102N are set-top boxes, application distribution site 108 may be maintained by a set-top box manufacturer, a service provider, and/or an operating system provider. In some examples, an application distribution site may be referred to as an app store. Examples of commercially available application distribution sites include Google Play, the Apple App Store, BlackBerry World, Windows Phone Store, and the Amazon Appstore.

Social media site 124 represents an example of a social media service. Social media site 124 may be configured to allow users of computing devices 102A-102N to communicate with one another. Social media site 124 may be configured to host profile pages corresponding to users of computing devices 102A-102N. For example, social media site 124 may be configured such that users of computing devices 102A-102N are able to display messages and upload photos, videos, and other media to a user's profile page. Examples of commercially available social media sites include Facebook, YouTube, Linkedin, Google Plus, Twitter, Flickr, and Instagram. In addition to allowing users to maintain profile pages, social media site 124 may be configured to enable a user to associate an item of content with a user's profile page. For example, social media site 124 may enable a user to endorse and/or share a particular item of content. In one example, viewers of the user's profile page may be able to see the endorsement.

User profile site 126 represents an example of a site configured to store information associated with users of computing devices 102A-102N. For example, in the example where television service provider site 110 includes a cable television service provider and computing devices 102A-102N include set-top boxes, user profile site 126 may store information associated with a user's account, e.g., purchase history, subscription package information, etc. Further, in some examples, user profile site 126 may store user preference information. As described in further detail below, user preference information may be used to associate particular items of content and/or particular services with a particular user.

User preference information may include information indicating a user's preferences with respect to particular services and/or items of content. For example, user preferences may include at least one or more of the following: a user's favorite television channels, a user's preferred movie genres, a user's preferred actors, actresses, and/or directors, and a user's favorite sports teams. In one example, user preference information may include information explicitly provided by a user. For example, a user may indicate one or more favorite television programs through a menu provided by one of computing devices 102A-102N. Further, user preference information may be determined implicitly. For example, user preference information may be based on any and all combinations of consumption, behavior, and environment. In one example, consumption may include items of content a user has accessed or is accessing. In one example, behavior may include user usage information such as, for example, how fast the user changes channels, how often the user skips commercials, how frequently a user accesses content through a computing device. In one example, environment may include time (e.g., hour, day, month, or year) and location (e.g., home, car, or airport) of a computing device. It should be noted that in some examples, user preference information stored at user profile site 126 may be generated with a first service and accessed by a second service. For example, user preference information may be generated based on a user's interactions with a social media service and may be accessed by a television service in order to recommend particular items of content to a particular user. As described in further detail below, user preference information may be used to dynamically generate graphical user interfaces.

As illustrated in FIG. 1, in addition to being configured to receive digital media content from communications network 104, computing devices 102A-102N may be configured to communicate with companion device(s) 130 either directly or through communications network 104. Companion device(s) 130 may be equipped for wired and/or wireless communications and may include, for example, a desktop, a laptop, or a tablet computer, a smartphone, or a personal gaming device. In the example illustrated in FIG. 1, companion device(s) 130 may be configured to communicate directly with computing devices 102A-102N (e.g., using a short range or near field communications protocol, e.g., Bluetooth), communicate with computing devices 102A-102N via a local area network (e.g., through a Wi-Fi router), and/or communicate with a wide area network (e.g., a cellular network). Further, companion device(s) 130 may act as a client device for one of computing devices 102A-102N. For example, companion device(s) 130 may be configured to act as a Universal Plug and Play (UPnP) client or a multicast Domain Name System (mDNS) client. In one example, companion device(s) 103 may be registered with one (or more) of computing devices 102A-102N using its media access control (MAC) address or a unique device identifier and/or a user's subscriber identifier. Companion device(s) 130 may execute applications in conjunction with computing devices 102A-102N. As described in detail below, companion device(s) 130 may be configured to provide user interfaces that enable users to select items of content. In one example, upon selection through a user interface of a companion device, an item of content may be presented on one of computing devices 102A-102N. It should be noted that although a single companion device is illustrated in the example of FIG. 1, each computing device 102A-102N may be associated with one or more companion device(s) 130. For example, each member of a household may have a companion device (e.g., a smartphone) associated with a computing device (e.g., a set-top box).

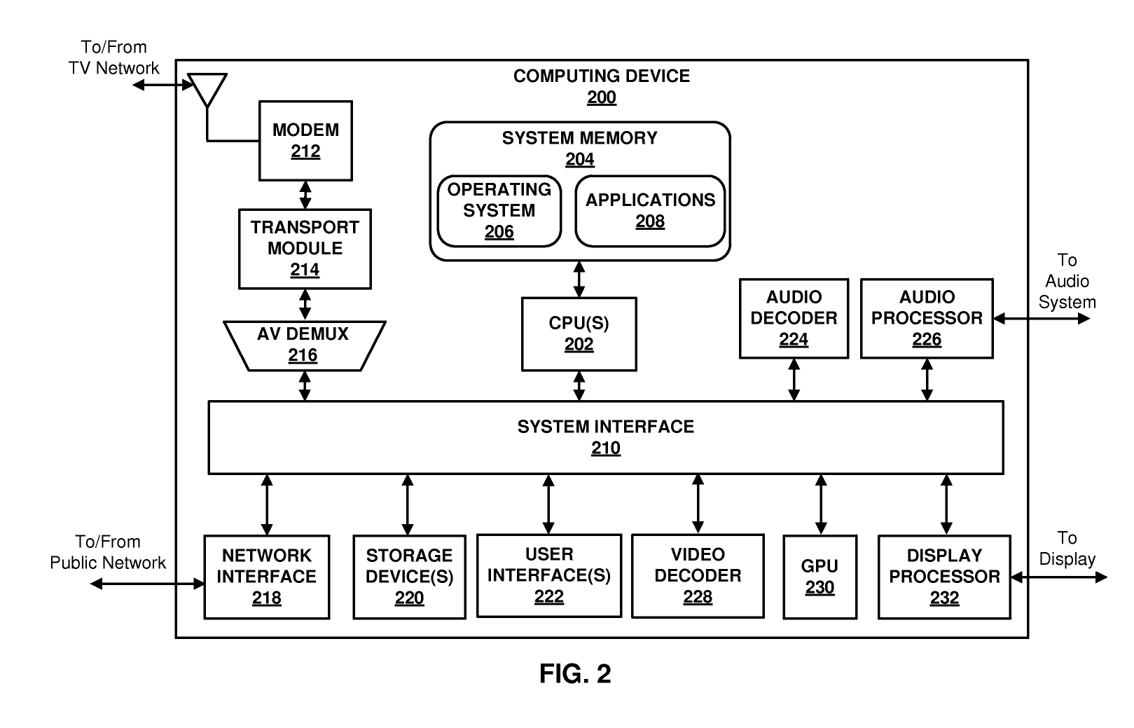

FIG. 2 is a block diagram illustrating an example of a computing device that may implement one or more techniques of this disclosure. Computing device 200 is an example of a computing device that may be configured to transmit data to and receive data from a communications network, allow a user to access multimedia content, and execute one or more applications. Computing device 200 may include or be part of a stationary computing device (e.g., a desktop computer, a television, a set-top box, a gaming console, a dedicated multimedia streaming device, or a digital video recorder), a portable computing device (e.g., a mobile phone, a laptop, or a tablet device) or another type of computing device. In the example illustrated in FIG. 2, computing device 200 is configured to send and receive data via a television network, such as, for example, television network 106 described above, and send and receive data via a public network, such as, for example, public network 108. It should be noted that in other examples, computing device 200 may be configured to send and receive data through one of a television network 106 or a public network 108. Further, in the example illustrated in FIG. 2 computing device 200 is configured to communicate with a companion device. The techniques described herein may be utilized by devices configured to communicate using any and all combinations of communications networks.

As illustrated in FIG. 2, computing device 200 includes central processing unit(s) 202, system memory 204, system interface 210, modem 212, transport module 214, AV demux 216, network interface 218, storage devices 220, user interface(s) 222, audio decoder 224, audio processor 226, video decoder 228, graphics processing unit 230, and display processor 232. As illustrated in FIG. 2, system memory 204 includes operating system 206 and applications 208. Each of processor(s) 202, system memory 204, system interface 210, modem 212, transport module 214, AV demux 216, network interface 218, storage devices 220, user interface(s) 222, audio decoder 224, audio processor 226, video decoder 228, graphics processing unit 230, and display processor 232 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although example computing device 200 is illustrated as having distinct functional blocks, such an illustration is for descriptive purposes and does not limit computing device 200 to a particular hardware architecture. Functions of computing device 200 may be realized using any combination of hardware, firmware and/or software implementations.

CPU(s) 202 may be configured to implement functionality and/or process instructions for execution in computing device 200. CPU(s) 202 may be capable of retrieving and processing instructions, code, and/or data structures for implementing one or more of the techniques described herein. Instructions may be stored on a computer readable medium, such as system memory 204 or storage devices 220. CPU(s) 202 may include multi-core central processing units.

System memory 204 may be described as a non-transitory or tangible computer-readable storage medium. In some examples, system memory 204 may provide temporary and/or long-term storage. In some examples, system memory 204 or portions thereof may be described as non-volatile memory and in other examples portions of system memory 204 may be described as volatile memory. Examples of volatile memories include random access memories (RAM), dynamic random access memories (DRAM), and static random access memories (SRAM). Examples of non-volatile memories include magnetic hard discs, optical discs, floppy discs, flash memories, or forms of electrically programmable memories (EPROM) or electrically erasable and programmable (EEPROM) memories.

System memory 204 may be configured to store information that may be used by computing device 200 during operation. System memory 204 may be used to store program instructions for execution by CPU(s) 202 and may be used by software or applications running on computing device 200 to temporarily store information during program execution. For example, system memory 204 may store instructions associated with operating system 206 and applications 208. Applications 208 may include applications implemented within or executed by computing device 200 and may be implemented or contained within, operable by, executed by, and/or be operatively/communicatively coupled to components of computing device 200. Applications 208 may include instructions that may cause CPU(s) 202 of computing device 200 to perform particular functions. Applications 208 may include algorithms which are expressed in computer programming statements, such as, for-loops, while-loops, if-statements, do-loops, etc. Applications 208 may be distributed to computing device 200 through an application distribution site, such as, for example, application distribution site 122 described above.

As further illustrated in FIG. 2, applications 208 may execute in conjunction with operating system 206. That is, operating system 206 may be configured to facilitate the interaction of applications 208 with CPUs(s) 202, and other hardware components of computing device 200. It should be noted that in some examples, components of operating system 206 and components acting in conjunction with operating system 206 may be referred to as middleware. The techniques described herein may be utilized by devices configured to operate using any and all combinations of software architectures. Operating system 206 may be an operating system designed to be installed on laptops, desktops, smartphones, tablets, set-top boxes, digital video recorders, televisions and/or gaming devices. In one example, operating system 206 may include one or more of operating systems or middleware components developed by OpenTV, Windows operating systems, Linux operation systems, Mac operating systems, Android operating systems, and any and all combinations thereof.

System interface 210 may be configured to enable communications between components of computing device 200. In one example, system interface 210 comprises structures that enable data to be transferred from one peer device to another peer device or to a storage medium. For example, system interface 210 may include a chipset supporting Accelerated Graphics Port (“AGP”) based protocols, Peripheral Component Interconnect (PCI) bus based protocols, such as, for example, the PCI Express™ (“PCIe”) bus specification, which is maintained by the Peripheral Component Interconnect Special Interest Group, or any other form of structure that may be used to interconnect peer devices.

Storage devices 220 represent memory of computing device 200 that may be configured to store relatively larger amounts of information than system memory 204. For example, in the example where computing device 200 is included as part of a digital video recorder, storage devices 220 may be configured to store numerous video files. Similar to system memory 204, storage device(s) 220 may also include one or more non-transitory or tangible computer-readable storage media. Storage device(s) 220 may include internal and/or external memory devices and in some examples may include volatile and non-volatile storage elements.

User interface(s) 222 may include devices configured to receive input from a user during operation of computing device 200. For example, user interface(s) 222 may include buttons and switches, motion sensors (e.g., accelerometers), touch-sensitive sensors, a track pad, a mouse, a keyboard, a microphone, a video camera, or any other type of device configured to receive user input. User interface(s) 222 may be integrated into computing device 200. For example, in the case where computing device 200 includes a television, user interface(s) 222 may include push buttons located on the television. Further, user interface(s) 222 may be integrated into devices external to computing device 200. For example, user interface(s) 222 may include one or more buttons located on a remote control in communication with computing device 200. Further, in one example, user interface(s) 222 may be integrated into a companion device, such as, for example, companion device 300 described in detail below. In some examples, a device including user interfaces(s) 222 may be operatively coupled to computing device 200 using a standardized communication protocol, such as for example, Universal Serial Bus protocol (USB), Bluetooth, ZigBee or a proprietary communications protocol, such as, for example, a proprietary infrared communications protocol. It should be noted that techniques described herein may be generally applicable regardless of the type of device including a user interface and regardless of the manner in which the device communicates with computing device 200.

As described in detail below, user interface(s) 222 may include a display configured to display the graphical users interfaces described herein. For example, in the case where computing device 200 includes a television, a companion device (e.g., a smart phone or a dedicated remote controller) in communication with a television may include a user interface including a touch-sensitive display presenting a graphical user interface described herein. Further, as described in detail below, a user may provide commands to computing device 200 by activating portions of a displayed graphical user interface.

Referring again to FIG. 2, computing device 200 is configured to send and receive data via a television network, such as, for example, television network 106 described above and send and receive data via a public network, such as, for example, public network 108. A communications network may be described based on a model including layers that define communication properties, such as, for example, physical signaling, addressing, channel access control, packet properties, and data processing. In the example illustrated in FIG. 2, modem 212, transport module 214, and AV demux 216 may be configured to perform lower layer processing associated with television network 106 and network interface 218 may be configured to perform lower layer processing associated with public network 108.

In one example, modem 212 may be configured to perform physical signaling, addressing, and channel access control according to the physical and MAC layers utilized in a television provider network, such as, for example, television provider network 106. In one example, modem 212 may be configured to receive signals from a coaxial cable and/or an over-the-air signal and perform low level signal processing (e.g., demodulation). In one example, modem 212 may be configured to extract transport streams from signals received from a coaxial cable. In one example, a transport stream may be based on a transport stream defined by the Moving Pictures Experts Group (MPEG). In one example, a transport stream may include a plurality of program streams where each program stream respectively corresponds to a program available from a television network. Further, a transport stream may include a plurality of data streams (e.g., Program Map Table and EPG data).

Transport module 214 may be configured to receive data from modem 212 and process received data. For example, transport model 214 may be configured to receive a transport stream including a plurality of program streams and extract individual program streams from a received transport stream. In one example, a program stream may include a video stream, an audio stream, and a data stream. AV demux 216 may be configured to receive data from transport module 214 and process received data. For example, AV demux 216 may be configured to receive a program stream from transport module 214 and extract audio packets, video packets, and data packets. In one example, AV demux 216 may be configured to decapsulate packetized elementary video and audio streams from a transport stream. It should be noted that although modem 212, transport module 214, and AV demux 216 are illustrated as distinct functional blocks, the functions performed by modem 212, transport module 214, and AV demux 216 may be highly integrated and realized using any combination of hardware, firmware and/or software implementations.

Network interface 218 may be configured to enable computing device 200 to send and receive data via a public network. As described above, data sent or received via a public network may include data associated digital content, such as, for example, music, videos, images, webpages, messages, voice communications, and applications. Network interface 218 may include a network interface card, such as an Ethernet card, an optical transceiver, a radio frequency transceiver, or any other type of device configured to send and receive information. Network interface 218 may be configured to perform physical signaling, addressing, and channel access control according to the physical and MAC layers utilized in a public network, such as, for example, public network 108. Further, in a manner similar to that described above with respect to transport module 214 and A/V demux 216, network interface 218 may be configured to extract audio packets, video packets, and data packets from a data stream. For example, network interface 218 may be configured to extract video packets, audio packets, and data packets according to one or more of internet protocol (IP), transport control protocol (TCP), real time streaming protocol (RTSP), user datagram protocol (UDP), real time protocol (RTP), MPEG transport stream protocols, and IPTV protocols. It should be noted, that the techniques described herein are generally applicable to any and all methods of digital content distribution and are not limited to particular communication network implementations. For example, the techniques described herein may be applicable to digital content originating from one or more of a broadcast, a multicast, a unicast, an over-the-top content source, a personal video recorder (PVR), and a peer-to-peer content source. As described above, computing device 200 may be configured to communicate with a companion device, either directly or indirectly. In one example, network interface 218 may be configured to enable computing device 200 to communication with a companion device. For example, network interface 218 may be configured to enable computing device 200 to communicate with a companion device using a communications protocol (e.g., Bluetooth and/or Wi-Fi).

Referring again to FIG. 2, data associated with digital content, such as, for example, music, videos, images, webpages, messages, voice communications, and applications may be stored in a computer readable medium, such as, for example, system memory 204 and storage devices 220. Data stored on a memory device may be retrieved and processed by CPU(s) 202, audio decoder 224, audio processor 226, video decoder 228, graphics processing unit 230, and display processor 232. As described above, CPU(s) 202 may be capable of retrieving and processing instructions, code, and/or data structures for implementing one or more of the techniques described herein. Each of audio decoder 224, audio processor 226, video decoder 228, graphics processing unit 230, and display processor 232 may also be capable of retrieving and processing instructions, code, and/or data structures for implementing one or more of the techniques described herein.

Audio decoder 224 may be configured to retrieve and process coded audio data. For example, audio decoder 224 may be a combination of hardware and software used to implement aspects of audio codec. Audio data may be coded using multi-channel formats such as those developed by Dolby and Digital Theater Systems. Audio data may be coded using a compressed or uncompressed format. Examples of compressed audio formats include MPEG-1, 2 Audio Layers II and III, AC-3, and AAC. Audio processor 226 may be configured to retrieve captured audio samples and may process audio data for output to an audio system (not shown). In some examples, audio processor 226 may include a digital to analog converter. An audio system may comprise any of a variety of audio output devices such as integrated speakers, headphones, a single-speaker system, a multi-speaker system, or a surround sound system. Video decoder 228 may be configured to retrieve and process coded video data. For example, video decoder 228 may be a combination of hardware and software used to implement aspects of a video codec. In one example, video decoder 228 may be configured to decode video data encoded according to any number of video compression standards, such as, ITU-T H.262 or ISO/IEC MPEG-2 Visual, ITU-T H.263, ISO/IEC MPEG-4 Visual, ITU-T H.264 (also known as ISO/IEC MPEG-4 AVC), VP8, and High-Efficiency Video Coding (HEVC).

As described above, a device with media playback capabilities may provide a graphical user interface (e.g., an EPG) that enables a user to select content. A graphical user interface may include images and graphics displayed in conjunction with video content (e.g., playback icons overlaid on a video). Graphics processing unit 230 is an example of a dedicated processing unit that may be configured to generate graphical user interfaces, including the graphical user interfaces described herein. That is, graphics processing unit 230 may be configured to receive commands and content data and output pixel data. Graphic processing unit 230 may operate according to a graphics pipeline process (e.g., input assembler, vertex shader, geometry shader, rasterizer, pixel shader, and output merger). Graphics processing unit 230 may include multiple processing cores and may be configured to operate according to OpenGL (Open Graphic Library, managed by the Khronos Group) and/or Direct3D (managed by Microsoft, Inc.).

Display processor 232 may be configured to retrieve and process pixel data for display. For example, display processor 232 may receive pixel data from video decoder 228 and/or graphics processing unit 230 and output data for display. Display processor 232 may be coupled to a display, such as display 250 (not shown in FIG. 1) using a standardized communication protocol (e.g., HDMI, DVI, DisplayPort, component video, composite video, and/or VGA). Display 250 may comprise one of a variety of display devices such as a liquid crystal display (LCD), a plasma display, an organic light emitting diode (OLED) display, or another type of display device capable of presenting visual data to a user. Display 250 may include a standard definition television, a high definition television, or an ultra-resolution display. Further, display 250 may include an integrated display of a portable computing device (e.g., a mobile phone, a laptop, or a tablet device).

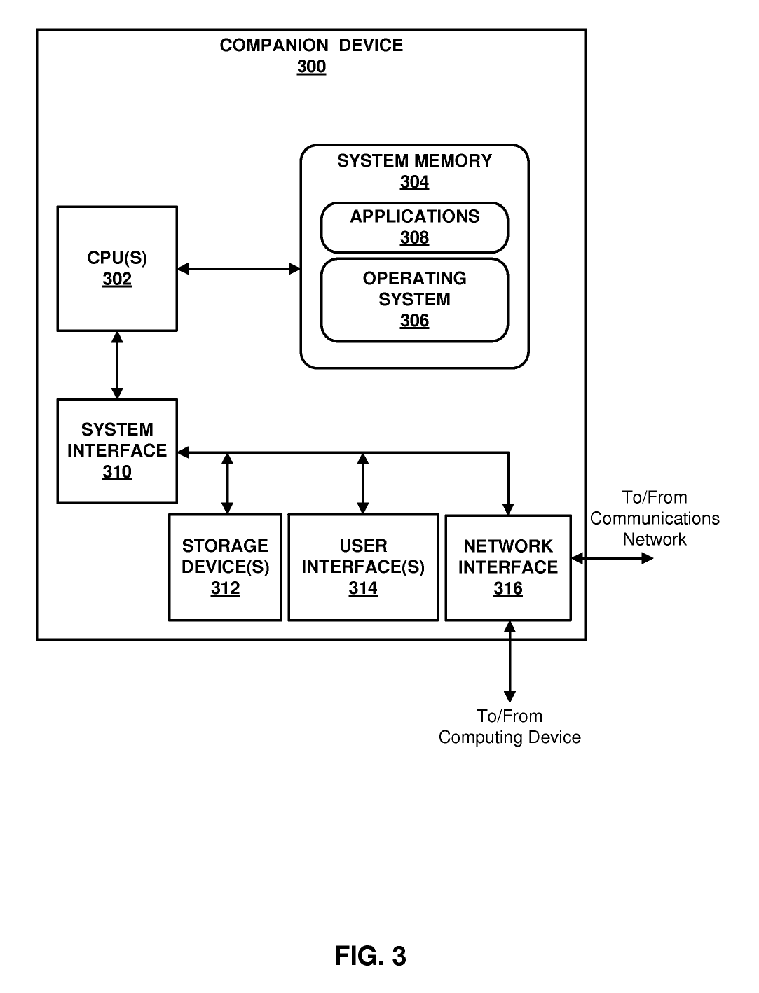

As described above, computing device 200 may be configured to send data to and receive data from a companion device. FIG. 3 is a block diagram illustrating an example of a companion device that may implement one or more techniques of this disclosure. As illustrated in FIG. 3, companion device 300 includes central processor unit(s) 302, system memory 304, system interface 310, storage device(s) 312, user interface(s) 314, and network interface 316. As illustrated in FIG. 3, system memory 304 includes operating system 306 and applications 308. It should be noted that although example companion device 300 is illustrated as having distinct functional blocks, such an illustration is for descriptive purposes and does not limit companion device 300 to a particular hardware or software architecture. For example, in some instances, companion device 300 may include a combination of ASICs and basis circuitry to implement the functions described herein. That is, in some examples, companion device 300 may not include a dedicated central processing unit and an operating system. Functions of companion device 300 may be realized using any combination of hardware, firmware and/or software implementations.

Referring again to FIG. 3, each of central processor unit(s) 302, system memory 304, and system interface 310, may be similar to central processor unit(s) 202, system memory 204, and system interface 210 described above. Storage device(s) 312 represent memory of companion device 300 that may be configured to store larger amounts of data than system memory 304. Storage device(s) 312 may be internal or external memory and in some examples may include non-volatile storage elements. For example, storage device(s) 312 may include memory cards (e.g., a Secure Digital (SD) memory card), and/or an internal solid state drive.

User interface(s) 316 may include devices configured to receive input from a user. For example, user interface(s) 316 may be similar to user interface(s) 222 described above, and may include buttons and switches, motion sensors, a touch-sensitive sensors, a track pad, a mouse, a keyboard, a microphone, a video camera, or any other type of device configured to receive user input. In one example, user interface(s) 316 may include a touchscreen display configured to display one or more of the graphical user interfaces described herein. As described above and in further detail below, a user may provide commands to a computing device (e.g., a television or a set-top box) by activating portions of a graphical user interface displayed on a companion device 300.

Network interface 316 may be configured to enable companion device 300 to communicate with external computing devices, such as companion device 200 and other devices or servers. Further, in the example where companion device 300 includes a smartphone, or the like, network interface 316 may be configured to enable companion device 300 to communicate with a cellular network. Network interface 316 may include a network interface card, such as an Ethernet card, an optical transceiver, a radio frequency transceiver, or any other type of device that can send and receive information. Network interface 316 may be configured to operate according to one or more communication protocols such as, for example, a Global System Mobile Communications (GSM) standard, a code division multiple access (CDMA) standard, a 3rd Generation Partnership Project (3GPP) standard, an Internet Protocol (IP) standard, a Wireless Application Protocol (WAP) standard, Bluetooth, ZigBee, and/or an IEEE standard, such as, one or more of the 802.11 standards, as well as various combinations thereof.

As illustrated in FIG. 3, system memory 304 includes operating system 306 and applications 308 stored thereon. Operating system 306 may be configured to facilitate the interaction of applications 308 with central processing unit(s) 302, and other hardware components of companion device 300. Operating system 306 may be an operating system designed to be installed on laptops and desktops. For example, operating system 306 may be a Windows® operating system, Linux, or Mac OS. Operating system 306 may be an operating system designed to be installed smartphones, tablets, and/or gaming devices. For example, operating system 306 may be an Android, iOS, WebOS, Windows Mobile®, or a Windows Phone® operating system. It should be noted that the techniques described herein are not limited to a particular operating system.

Applications 306 may be any applications implemented within or executed by companion device 300 and may be implemented or contained within, operable by, executed by, and/or be operatively/communicatively coupled to components of companion device 300. Applications 306 may include instructions that may cause central processing unit(s) 302 of companion device 300 to perform particular functions. Applications 306 may include algorithms which are expressed in computer programming statements, such as, for loops, while-loops, if-statements, do-loops, etc. Further, applications 306 may include applications that enable a user to cause actions associated with items of content selection to be performed according to one or more of the techniques described herein.

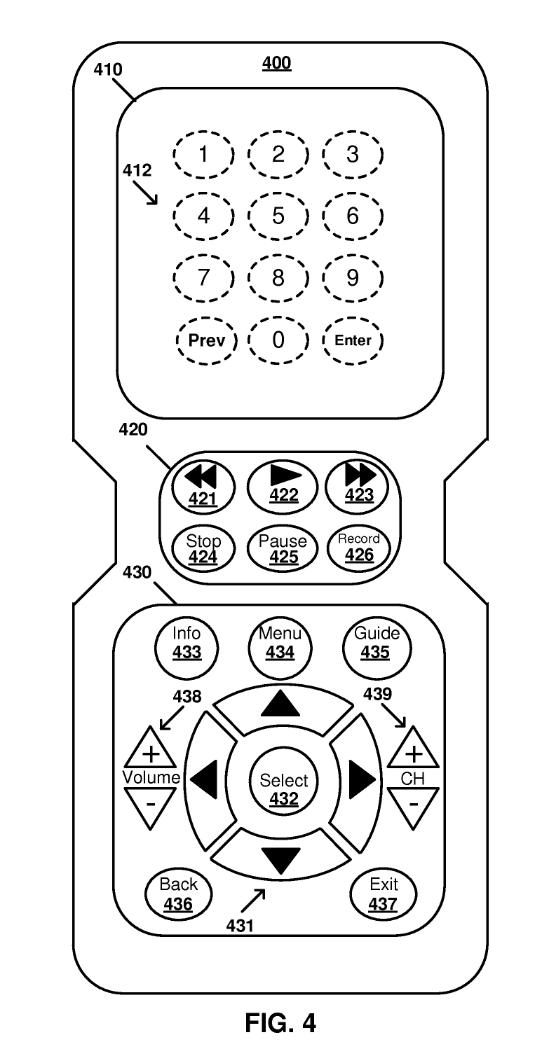

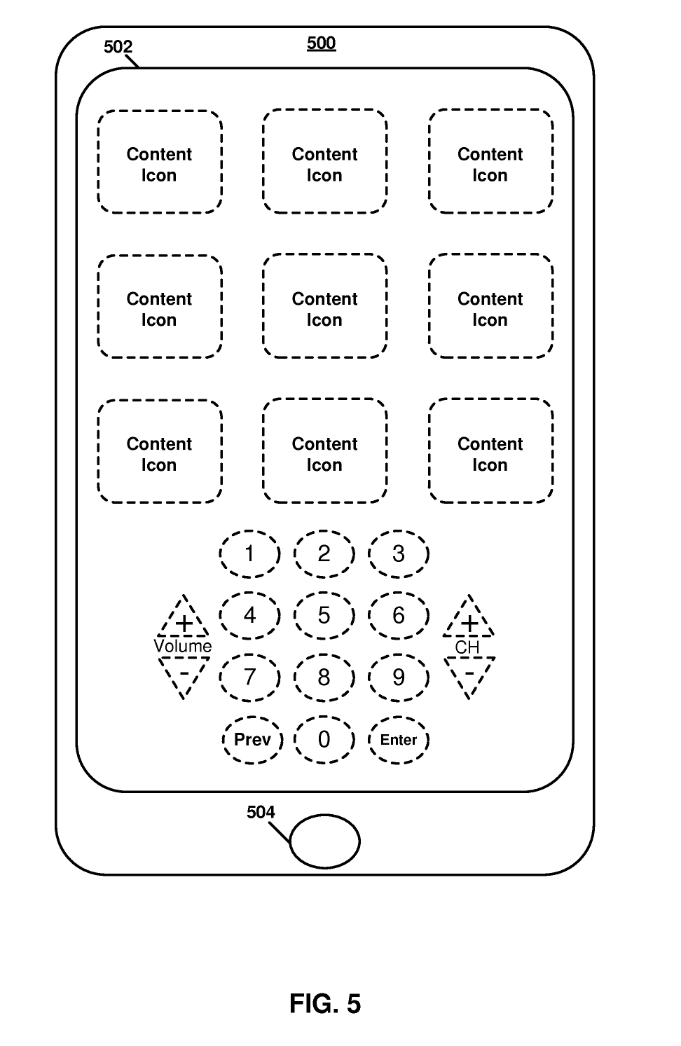

As described above, user interfaces may enable a user to provide commands to a computing device. FIG. 4 and FIG. 5 are conceptual diagrams illustrating example user interfaces that may implement one or more techniques of this disclosure. In the example illustrated in FIG. 4, user interface 400 includes touchscreen display 410 and push-buttons, i.e., playback controls 420, and navigational controls 430. In the example illustrated in FIG. 4, playback controls 420 and navigational controls 430 provide functions generally associated with a television service. Thus, in some examples, user interface 400 may be included as a user interface of a television remote control, a set-top box remote control, or a so-called “universal” remote control. In the example illustrated in FIG. 5, user interface device 500 includes touchscreen display 502 and button 504. In some examples, button 504 may be referred to as a Home button. In some examples, user interface 500 may be included as a user interface of a smartphone or a tablet computing device.

It should be noted that the techniques described herein are generally applicable regardless of the particular hardware and software implementations of a device including an example user interface described herein. For example, when a user interface described herein is implemented as part of a dedicated remote control device, functions may be implemented using ASICs or the like. Further, when a user interface described herein is implemented as part of a mobile computing device, functions may be implemented using applications available from an application distribution site, e.g., application distribution site 122.

Referring again to FIG. 4, touchscreen display 410 may include any display device configured to display a graphical user interface and receive a user touch input. For example, touchscreen display 410 may include an LCD display, an OLED display, or any other type of display device capable of presenting visual data to a user, and a capacitive touch sensor device, a resistive touch sensor device, or any other type of device capable of receiving user touch input. Further, it should be noted that touchscreen 410 may be configured to receive user touch input directly or indirectly (e.g., using a stylus). As described in detail below, touchscreen display 410 may be configured to display icons representing items of content. As further described in detail below, touchscreen display 410 may be configured to enable a user to perform multiple types of activations with respect to an icon. That is, touchscreen display 410 may be configured to process one or more of the following user touch inputs: a signal tap, a double-tap, a press of a specified duration (e.g., a long press), a multi-touch point input (e.g., a pinch gesture), and complex touch gestures (e.g., drag and drop gesture, character writing gestures, and swiping gestures).

In the example illustrated in FIG. 4, touchscreen 410 displays virtual buttons 412, where virtual buttons may replicate push-buttons. That is, a user may activate a virtual button by pressing a corresponding area on touchscreen display 410. It should be noted that in some instances virtual buttons may be referred to as soft keys. Further, it should be noted that example push-buttons illustrated in FIG. 4 may alternatively be implemented as virtual buttons and example virtual buttons illustrated in FIG. 4 may alternatively be implemented as push-buttons. In the example illustrated in FIG. 4, virtual buttons 412 replicate a numeric keypad, an enter button, and a previous channel button. In one example, upon a user entering a sequence of numbers using virtual numeric keypad and, optionally, additionally activating enter key, a tuner of a computing device may tune to a specified channel. Further, upon activation of virtual previous channel button, a tuner may tune to a previously tuned channel.

Playback controls 420 may be configured to enable a user to control the playback of content on a computing device. For example, playback controls 420 may enable a user to control the playback of a video originating from a media service provider site, an on demand engine, and/or a personal video recorder (PVR). As illustrated in FIG. 4, playback controls 420 include reverse playback button 421, normal playback button 422, forward playback button 423, stop playback button 424, pause playback button 425, and record button 426. Reverse playback button 421 may enable a user to navigate to a previous point in a multimedia sequence. Upon activation, normal playback button 422 may cause normal playback of an item of multimedia content to begin or resume. Forward playback button 423 may enable a user to navigate to a future point in a multimedia sequence. Upon activation, stop playback button 424 may cause the playback of an item of multimedia content to cease. Upon activation, pause playback button 425 may cause the playback of an item of multimedia content to be paused. Record button 426 may enable a user to cause an item of multimedia content to be stored to a storage device, i.e., enable a user to time-shift an item of multimedia content. It should be noted that although playback controls 420 may be configured to enable a user to control the playback of multimedia content, in some examples playback controls 420 may be used to perform other functions associated with a computing device.

As described above, devices with digital media playback capabilities, including, for example, televisions, set-top boxes, and mobile devices, may be configured to provide users thereof with graphical user interfaces that enable the selection of content. Navigational controls 430 may be configured to enable a user to navigate graphical user interfaces and select content using a graphical user interface. In one example, navigational controls 430 may be configured to enable a user to navigate graphical user interfaces and select content using one of more of the example graphical user interfaces described herein. Further, navigational controls 430 may be configured to enable a user to perform basic tuning and volume control functions associated with viewing television programming or the like.

As illustrated in FIG. 4 navigational controls 430 include navigational arrow buttons 431, select button 432, information button 433, menu button 434, guide button 435, back button 436, exit button 437, volume control buttons 438, and channel change buttons 439. In the example illustrated in FIG. 4, navigational arrow buttons 431 may be configured to move the position of a cursor associated with a graphical user interface and/or change the selection of an item included in a graphical user interface displayed on a computing device. Select button 432 may enable a user to further select an icon representing an item of content or select a sub-menu within a menu. Information button 433 may be configured to cause additional information associated with an item of content of to be displayed. For example, when an icon representing an item of content is initially selected, activation of information button 433 may cause information associated with the content (e.g., cast and crew information) to be displayed. Menu button 434, guide button 435, back button 436, and exit button 437 may be configured to enable a user to cause different graphical user interfaces to be presented on a computing device. Upon activation, menu button 434 may cause a graphical user interface including a high level menu to be displayed. In one example, a high level menu may include a menu that enables a user to change settings associated with the operation of a computing device. In one example, a high-level menu may include a menu that enables a user to select a user profile (e.g., a log-in graphical user interface). In one example, activation of menu button 434 may cause a graphical user interface to be presented on computing device that enables a user to set user preference information. For example, activation of menu button 434, may cause a graphical user interface to be presented on a computing device that enables a user to select a subset of available television channels as favorite channels.

Guide button 435 may be configured to cause a graphical user interface that enables a user to select content to be presented. In one example, upon activation of guide button 435, a graphical user interface including an EPG, (e.g., a grid guide) may be presented to a user on a computing device. Back button 436 may be configured to enable a user to return to a previous graphical user interface. Exit button 437 may be configured to enable a user to return to a full screen viewing mode. For example, when a graphical user interface is displayed, upon activation of exit button 437, the graphical user interface may “disappear” and full screen content viewing mode may be presented to a user. Activation of “+” and “−” volume control buttons 438 may respectively cause the output of an audio system to be increased and decreased. Activation of “+” and “−” channel buttons 439 may respectively cause a tuner (e.g., analog, and/or digital) to tune to the next channel in a sequence of channels.

Further, in other examples, user interface 400 may include a microphone and/or motion sensors. In these examples, functions achieved by activation of buttons of user interface 400 and/or touchscreen display 410 and/or other functions may be achieved through other types of user inputs. For example, in the example where user interface 400 includes a microphone, functions achieved by activation of buttons on user interface 400 may be achieved through voice commands. Further, in the example where user interface 400 includes a motion sensors, functions achieved by activation of buttons on user interface 400 may be achieved through user gestures. In one example, user interface 400 may be configured to enable a user to use voice commands to cause virtual buttons and/or icons representing items of content and/or menus to be displayed on touchscreen display 400. For example, a user saying “Display Keypad,” or the like, may cause virtual buttons 412 illustrated in the example of FIG. 4 to be displayed on touchscreen display 410. Further, in one example, a user may provide user preference information by providing voice commands. For example, if a computing device is tuned to a channel, a user saying “Add to Favorites,” or the like, may cause the channel to be added to a list of favorite channels. As described in further detail below, interface 400 may be configured to enable a user to cause icons representing items of content to be displayed on touchscreen display 410 using voice commands.

Referring again to FIG. 5, touchscreen display 502 may be similar to touchscreen display 410 described above. In the example illustrated in FIG. 5, touchscreen display 502 displays virtual buttons and icons representing items of content. Examples of icons representing items of content are described in further detail below. In the example illustrated in FIG. 5, one or more activations of button 504 may cause user touchscreen display 502 to return a home screen. That is, button 504 may cause difference graphical user interfaces to be displayed on touchscreen display 502. Further, button 504 may have different functionality based on a graphical user interface displayed on touchscreen display 502. Similar to user interface 400 described above, in some examples, user interface 500 may include a microphone and/or motion sensors and may be configured to receive voice and motion input, including the example voice and motion inputs described above.

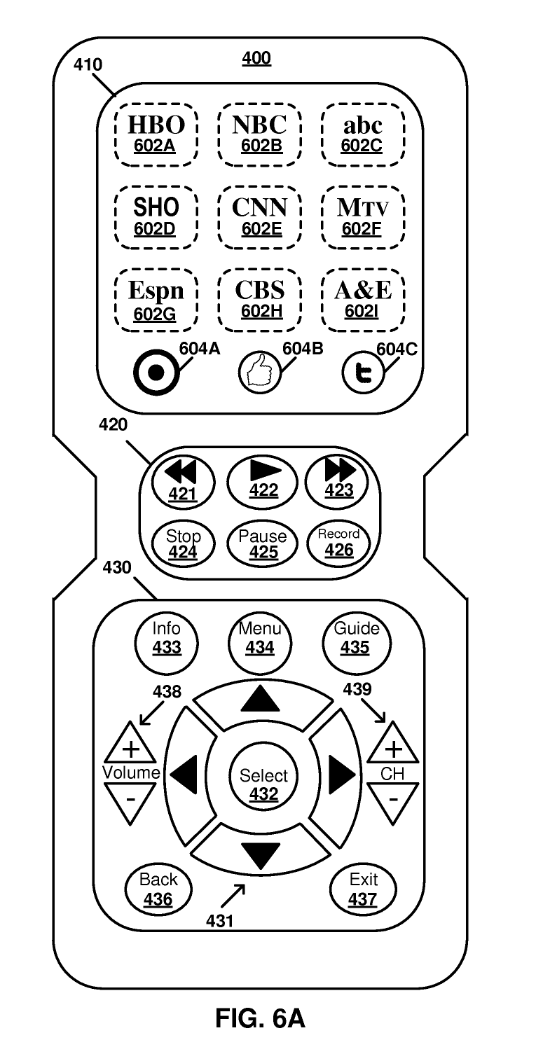

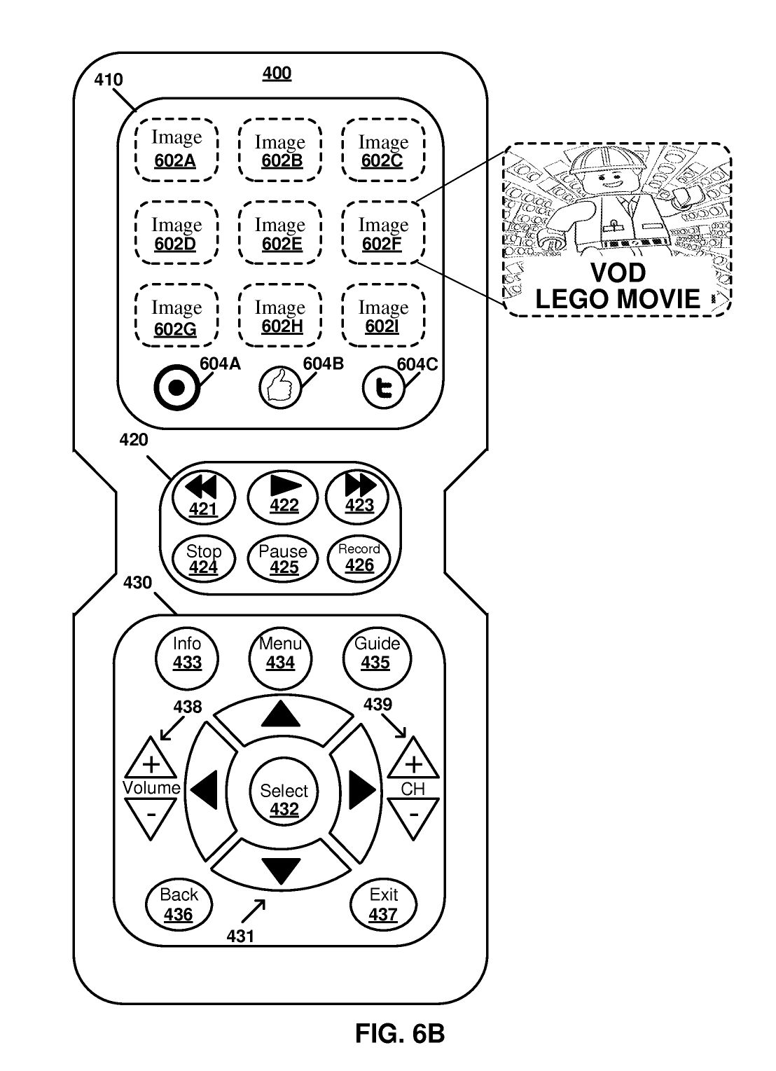

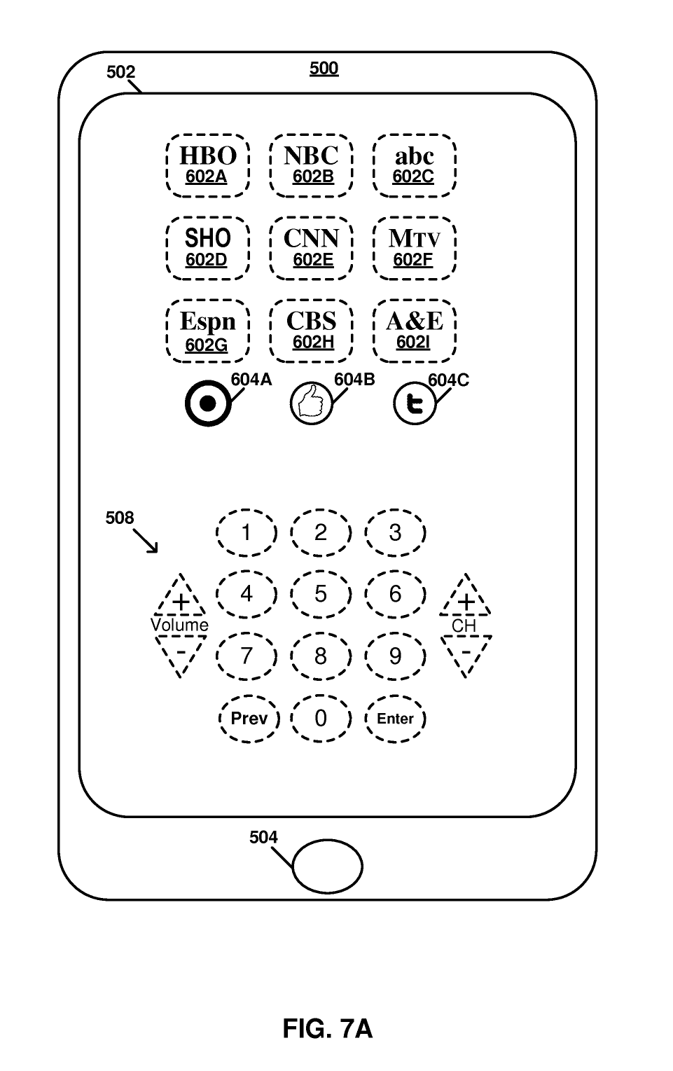

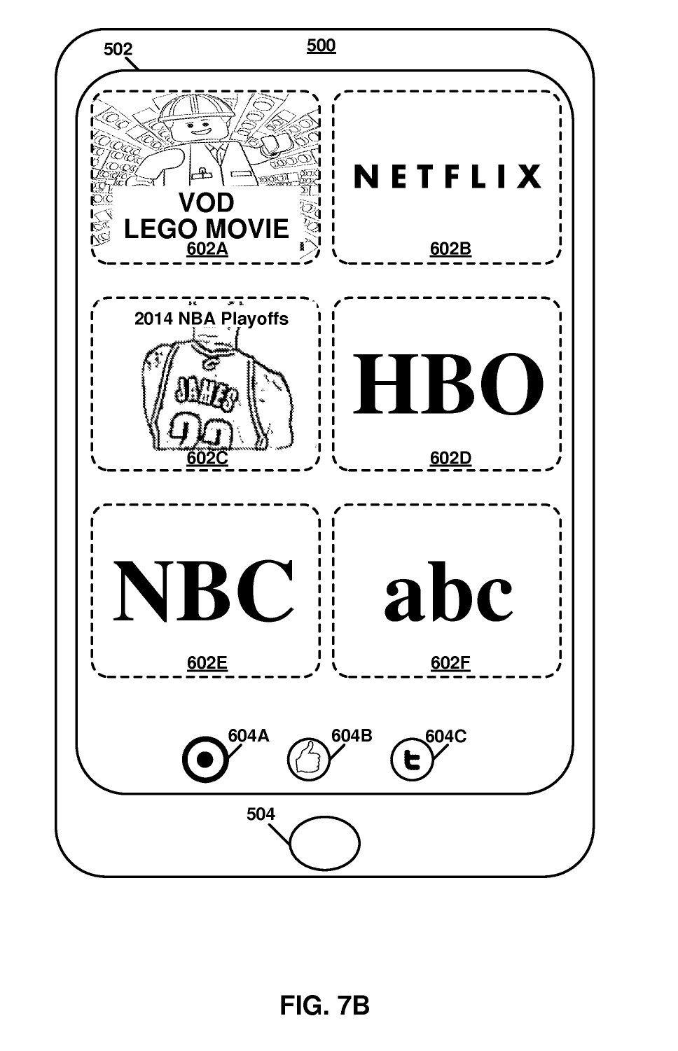

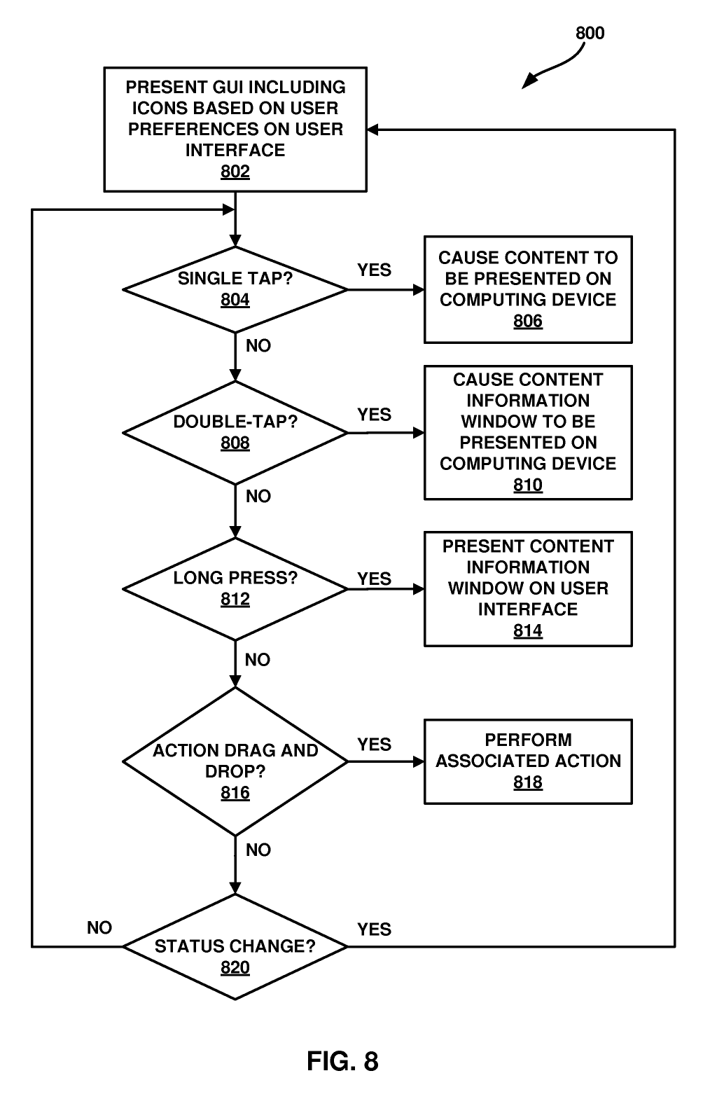

As described above, due to the numerous items of content that may be available to a user through one or more sources and the plurality of available actions with respect to an item of content, traditional graphical user interfaces and traditional push-button remote controllers may be less than ideal. FIGS. 6A-6B and FIGS. 7A-7B are conceptual diagrams illustrating example user interfaces that may enable a user to perform one or more actions associated with an item of content. FIGS. 6A-6B illustrate examples where a graphical user interface enabling a user to perform an action associated with an item of content is presented using user interface 400. FIGS. 7A-7B illustrate examples where a graphical user interface enabling a user to perform an action associated with an item of content is presented using user interface 500. FIG. 8 is a flowchart illustrating an example method that may enable a user to cause one or more actions associated with an item of content to be performed. The example method illustrated in FIG. 8 may be performed by a companion device including user interface 400 or user interface 500, or any other computing device including a user interface.

As illustrated in FIG. 8, at 802, a user interface, for example, user interface 400 or user interface 500, presents a graphical user interface including icons based on user preference information. FIGS. 6A-6B and FIGS. 7A-7B illustrate respective examples of graphical user interfaces including icons based on user preference information presented on a touchscreen display. As described above, a user interface may be configured display icons representing items of content upon receiving a voice command. For example, a graphical user interface illustrated in FIGS. 6A-7B may be displayed upon a user saying “Display favorites,” “My Content,” or the like. Further, in one example, a user interface may display a graphical user interface that may enable a user to cause a graphical user interface illustrated in FIGS. 6A-7B to be displayed. For example, a user interface may display a top-level menu graphical user interface including a “Favorites” icon, a “My Content” icon, or the like, that upon activation causes a graphical user interface illustrated in FIGS. 6A-7B to be displayed. Further, in one example, a graphical user interface respectively illustrated in FIGS. 6A-7B may be displayed upon a user performing a particular motion gesture.

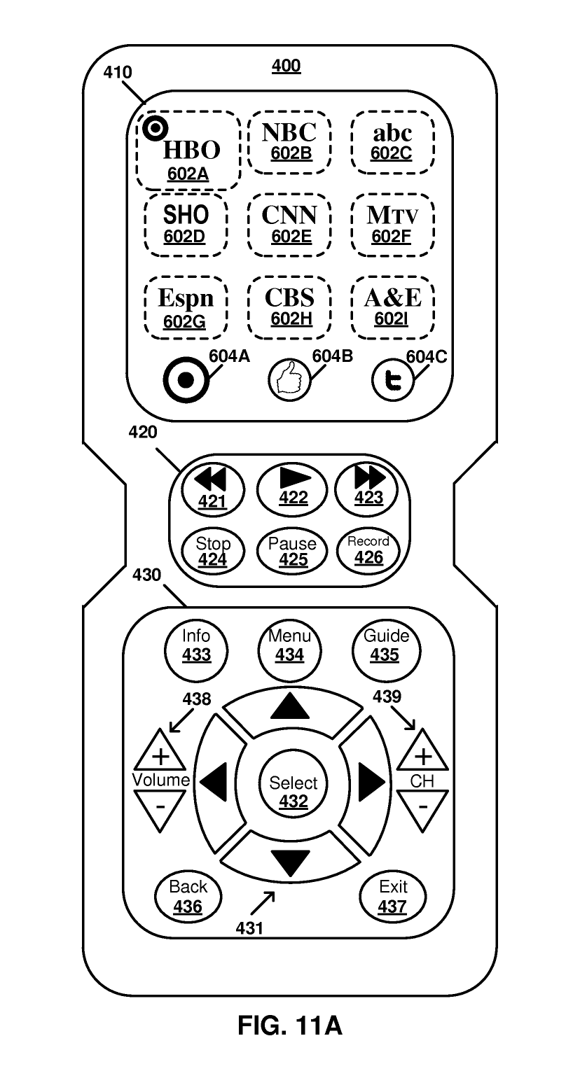

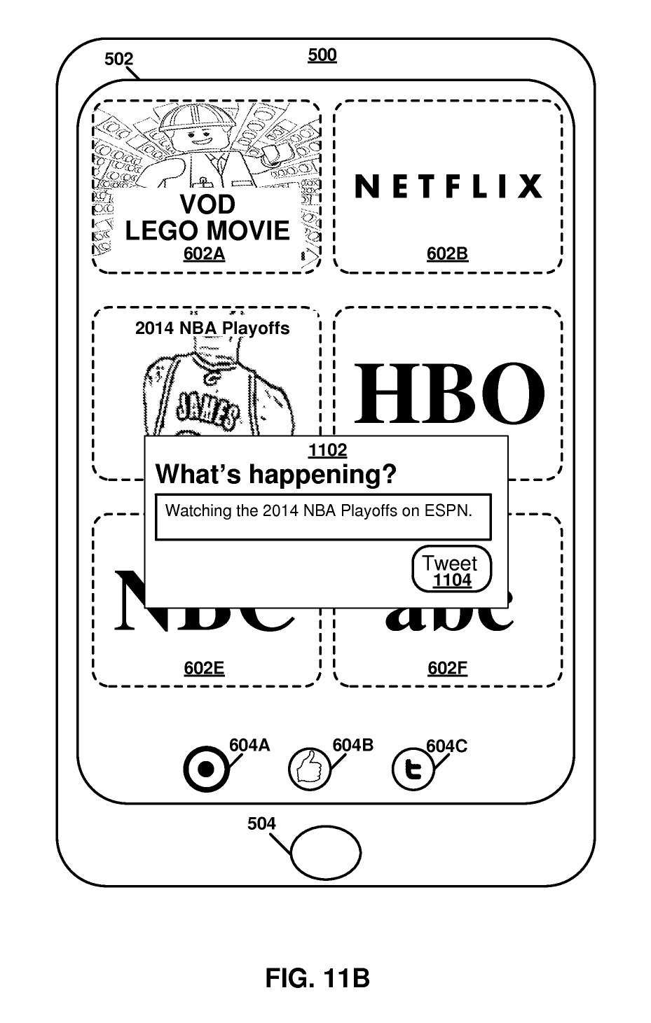

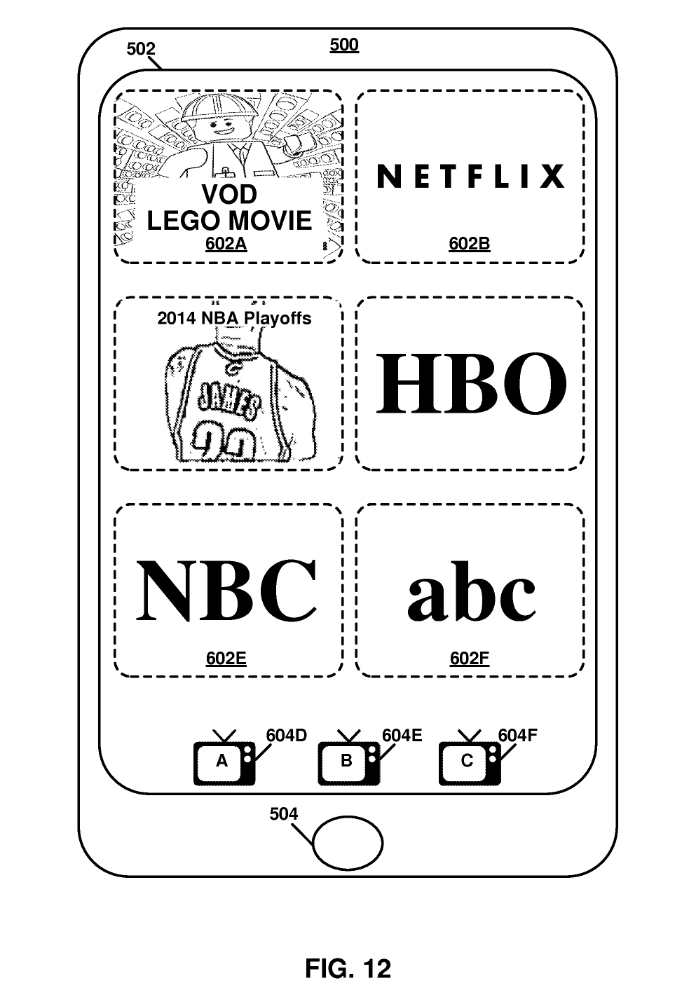

Each of the example graphical user interfaces illustrated in FIGS. 6A-6B and FIGS. 7A-7B include icons representing items of content 602A-602I and icons representing actions 604A-604C displayed on respective touchscreen displays. Icons representing actions 604A-604C are described in greater detail below with respect to FIGS. 11A-11B. Further, icons representing actions 604D-604F are described in greater detail below with respect to FIG. 12. In the example illustrated in FIG. 6A, touchscreen display 410 of user interface 400 displays icons representing items of content 602A-602I, wherein icons representing items of content 602A-602I include television networks. In the example illustrated in FIG. 6B, touchscreen display 410 of user interface 400 displays icons representing items of content 602A-602I, wherein icons representing items of content 602A-602I include available television programming, video on demand content, available media streaming services, and television networks. In the example illustrated in FIG. 7A, touchscreen display 502 of user interface 500 displays icons representing items of content 602A-602I, wherein icons representing items of content 602A-602I include television networks. In the example illustrated in FIG. 7B, touchscreen display 502 of user interface 500 displays icons representing items of content 602A-602F, wherein icons representing items of content 602A-602F include video on demand content, services and television networks. Thus, items of content presented based on user preference information may include items of content of a single type (e.g., television channels, currently airing television programming, on demand content, media streaming services, applications, etc.) and/or items of content of different types. In one example, a user may be able to determine which types of items of content are allocated to icons. For example, in the case where there are nine available icons (602A-602I), a user could assign favorite television networks to icons 602A-602C, favorite applications to icons 602D-602F, and favorite video on demand (VOD) portals to icons to 602G-602I.

As described above, user preference information may include information explicitly provided by a user and/or user preference information may include information determined implicitly (e.g., using one or more of consumption, behavior, and environment). Referring to the examples respectively illustrated in FIGS. 6A and 7A. In each of these examples, icons representing items of content 602A-602I include a user's favorite channels and include text and/or logos representing television channels. In one example, a user may explicitly provide a list of favorite channels. For example, a user may add one or more channels (e.g., HBO, Showtime, CNN, CBS, etc.) to a favorite channel list using an EPG grid guide presented on a computing device, e.g., computing device 200. Further, as described above a user may add channels to a favorite channels list by providing voice command to a user interface (e.g., “Add HBO to favorites”).

In one example, a favorite channel list may be stored on a storage device of a computing device (e.g., a storage device of a set-top box). Additionally or alternatively, a favorite channel list may be stored on a storage device of a companion device. Further, in one example, additionally or alternatively, a favorite channel list may be stored at a user profile site, e.g., user profile site 126. As described above, a companion device including user interface 400 or user interface 500 may be configured to communicate with a computing device either directly or indirectly and/or access a wide area network. Thus, a companion device may obtain a list of favorite channels by any combination of user input, through communication with a computing device, and/or through communication with a user profile site.

In one example, where a computing device includes a television or a set-top-box a companion device including a user interface may obtain a list of favorite channels via Bluetooth, Wi-Fi, or NFC. Further, in this example, the companion device may be registered with the computing device using its MAC-address, a unique device ID, and/or a user's subscriber ID. In one example, once a companion device is registered, it is able access to the user's favorite channel list from the computing device. In one example, a computing device may advertise a favorite channel list using either UPnP or mDNS. Further, using private extensions, computing device may also provide channel logos (e.g., for display on a touchscreen of a companion device) for an associated favorite channel list.

Additionally or alternatively, a favorite channel list may be synced from a computing device to a cloud based server. In this example, a companion device can then simply contact the cloud based service to acquire a favorite channel list and/or associated channel logos. It should be noted that is some examples, having user preference information stored on a server may allow a user to personalize any capable hardware remote control. For example, a user could go to a vacation home having television services and auto-configure a remote control (e.g., a remote control associated with a set-top box) by downloading user preference information from a server. In one example, a companion device may acquire the names of the channels included in a favorite channel list and query a web page content distribution site, e.g., webpage content distribution site 120 for the associated channel logos and/or images. Thus, a companion device including user interface 400 or user interface 500 may be configured such that upon on acquiring user preference information, which may include a favorite channel list, to present icons representing items of content based on the user preference information.

As described above, user preference information may include information determined implicitly (e.g., using one or more of consumption, behavior, and environment). In one example, a computing device and/or a companion device may be configured to recognize a user's patterns with respect to accessing content. For example, a companion device may recognize that a user watches particular channels and/or particular television programming on certain days and/or certain times of the day. In one example, a favorite channel list and/or other user preference information may be generated based on a recognized pattern. Further, in one example, channels included in a favorites channel list may be presented in a graphical user interface based on recognized patterns. For example, a companion device may be configured to arrange and/or re-arrange the position of icons based on recognized user behavior. For example, a user's favorite channel list may include HBO, CNN, ABC, FOX and NBC. A companion device and/or a computing device may recognize that on Thursdays the user typically watches “Homeland” on Showtime and the News on CNN and on Fridays the user typically watches “Game of Thrones” on HBO and “The Voice” on NBC. In one example, a companion device may be configured to arrange the icons for Showtime and CNN in the top row of a graphical user interface on Thursday and arrange the icons for HBO and NBC in the top row on a graphical user interface on Friday. In this manner, a companion device may be configured arrange the presentation of a plurality of icons representing items of content based on a likelihood of selection by the user.

Referring again to FIG. 8, after icons representing items of content are presented on a user interface, a companion device including user interface 400 or user interface 500 may determine if a particular type of activation of an icon is performed by a user. In the example illustrated in FIG. 8, there are four particular types of activations, a single tap, a double-tap, a long press, and an action drag and drop. In one example, a single tap may include pressing and releasing an icon. In one example, a double-tap may include pressing and releasing an icon twice within a specified time period. In one example, a long press may include a user pressing and not releasing an icon until a specified duration expires. In one example, an action drag and drop may include a user dragging and dropping (pressing, sliding, and releasing) one of action icons 604A-604C on an icon representing an item of content. It should be noted that in other examples, there may be more or fewer types of activations of icons. For example, in one example a user may perform a counterclockwise and/or a clockwise rotation of an icon (e.g., by pressing an icon and rotating a finger and/or pressing an icon and drawing an arc). In one example, a counterclockwise rotation may have the effect of reverse playback button 421 and a clockwise rotation may have the effect of forward playback button 423 for an item of content associated with the icon. Further, each of the activations included in the example illustrated in FIG. 8 may be associated with other actions. For example, in one example, a single tap may cause an informational window to be presented and a double-tap may cause an item of content to be presented on a computing device.

Referring again to FIG. 8, in the example illustrated in FIG. 8, a companion device may be configured to determine if one of the following occurs a single tap (804), a double-tap (808), a long press (812) or an action drag and drop (816). In the example illustrated in FIG. 8, upon determining that a single tap activation of an icon representing an item of content occurs, a companion device may cause the item of content to be presented on a computing device (806). For example, a user performing a single tap on an icon representing HBO (e.g., icon 602A in FIG. 6A, icon 602A in FIG. 7A, and icon 602D in FIG. 7B) may cause a computing device (e.g., a television or a set-top box) to tune to HBO. In this manner, a user does not need to key-in a channel number associated with HBO to access HBO. It should be noted that when an item of content includes a service (e.g., Netflix service, as illustrated as icon 602B in FIG. 7B) presenting an item of content on a computing device may include launching an application associated with a service. Further, when an item of content includes on demand content (e.g., Lego Movie, illustrated as icon 602F in FIG. 6B and icon 602A in FIG. 7B) presenting an item of content on a computing device may include launching a video on demand portal. In some examples, this may enable a user to confirm a purchase. Further, when an item of content includes a particular television program (e.g., NBA Playoffs, illustrated as icon 602C in FIG. 7B) presenting an item of content on a computing device may include tuning to a channel airing the particular television program. It should be noted that causing a particular television program to be presented through activation of an icon may be particularly useful for enabling a user to tune to an event when a user is unaware of a television channel associated with the event. In this manner, presenting an icon of content representing an item of content based on user preference information and enabling a user to perform one of a plurality of types of activations on the icons enables a user to efficiently cause an item of content to be presented.

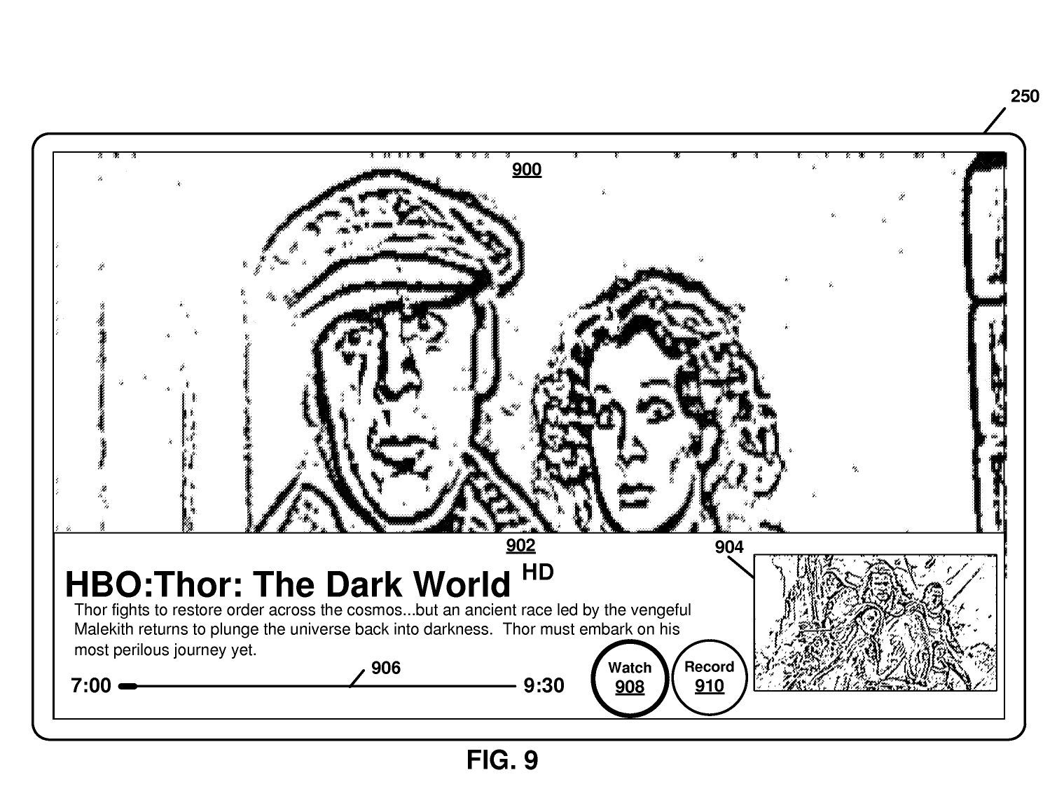

Referring again to FIG. 8, upon determining that a double-tap activation of an icon representing an item of content occurs, a companion device may cause an information window to be presented on a computing device (810). FIG. 9 illustrates an example of a graphical user interface including an information window that may be presented on a computing device. In the example illustrated in FIG. 9, graphical user interface 900 is presented on display 250. As illustrated in FIG. 9, graphical user interface 900 includes video content presented to a user, which may include a currently tuned channel, and information window 902 overlaid on video content.

In the example illustrated in FIG. 9, a user performs a double-tap on an icon representing HBO. In the example illustrated in FIG. 9, information window 902 includes a text description, an image associated an item of content 904, progress indicator 906, a watch icon 908, and a record icon 910. An image representing an item of content 904 provides a user with a visual preview of content associated with an item of content. It should be noted that in some examples, image 904 may include a video, including a trailer and/or television programming in progress. In the example illustrated in FIG. 9, progress indicator 906 provides a user with a visual representation of the completion status of television programming. Upon activation, watch icon 908 may cause computing device to present the content associated with the item of content to be presented (e.g., in a full screen presentation) on display 250. Upon activation, record icon 910 may cause computing device to store the content associated with the item of content to a storage device. It should be noted that each of watch icon 908 and record icon 910 may be selected and activated using interface 400 or interface 500. For example, a user may select one of watch icon 908 or record icon 910 using navigational arrow buttons 431 and activate one of watch icon 908 or record icon 910 by pressing select button 432. In this manner, presenting an icon of content representing an item of content based on user preference information and enabling a user to perform one of a plurality of types of activations on the icons enables a user to obtain additional information associated with an item of content and further enables a user, upon receiving additional information, to efficiently cause one or more actions associated with the item of content to be performed.

Referring again to FIG. 8, upon determining that a long press activation of an icon representing an item of content occurs, a companion device may cause an information window to be presented on a user interface (814). It should be noted that in some examples, in order to cause an information window to be presented on a user interface, a companion device may need to access a storage device including a program guide database. In one example, a companion device may request a program guide database from a computing device (e.g., from a set-top box using an HTTP request mechanism).

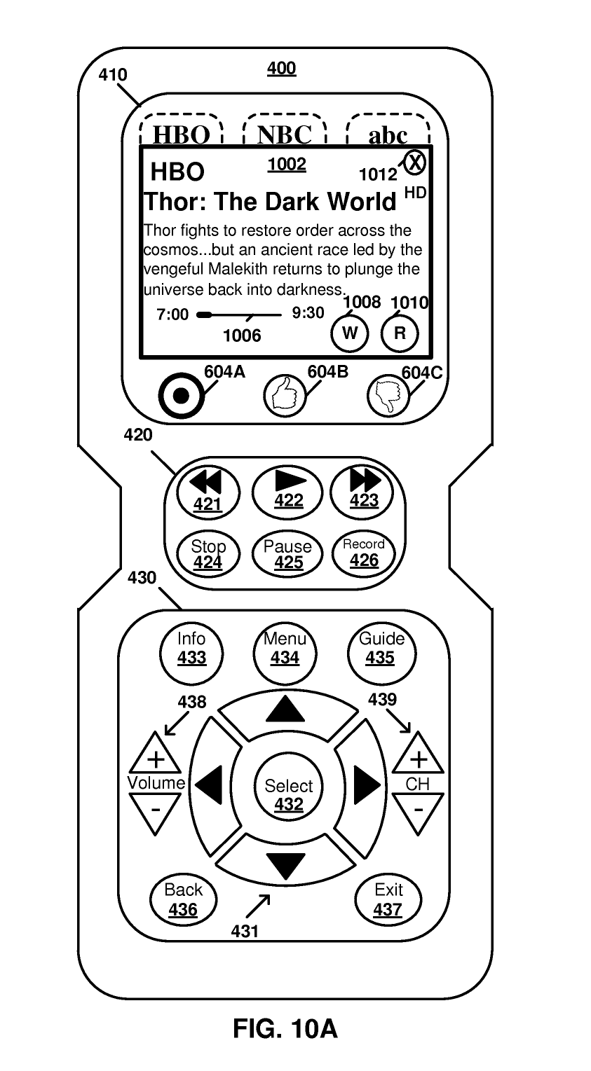

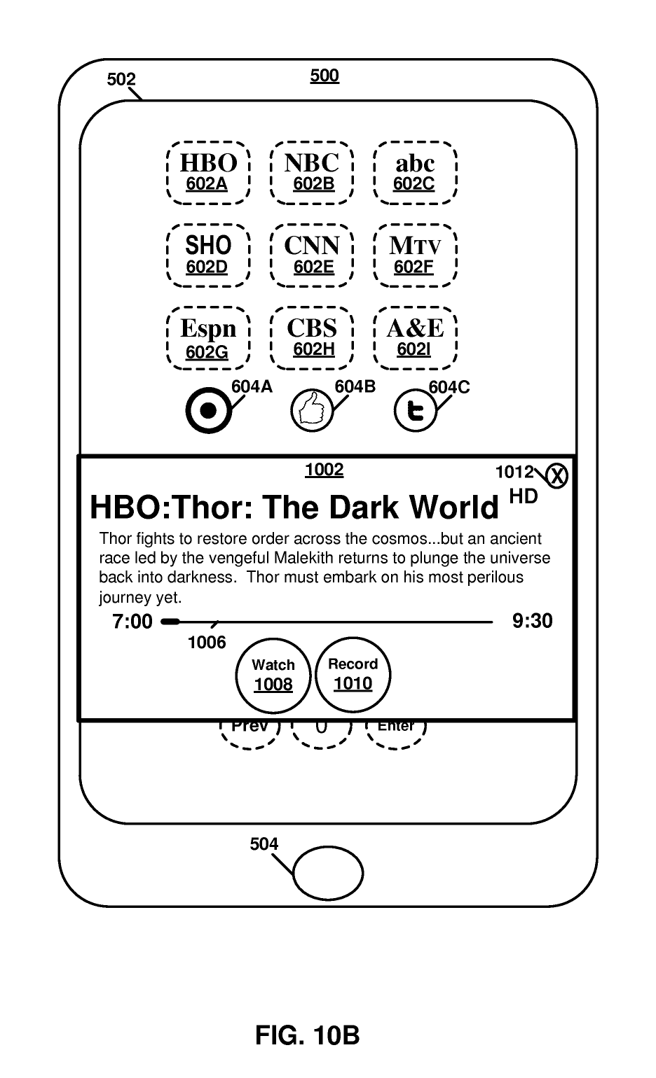

FIG. 10A illustrates an example of a graphical user interface including an information window that may be presented on a user interface 400. FIG. 10B illustrates an example of a graphical user interface including an information window that may be presented on a user interface 500. As respectively illustrated in each of FIG. 10A and FIG. 10B, information window 1002 includes a text description, progress indicator 1006, a watch icon 1008, and a record icon 1010. Each of progress indicator 1006, watch icon 1008, and record icon 1010 may be similar to progress indicator 906, watch icon 908, and record icon 910, described above with respect to FIG. 9. However, it should be noted that a user may be able to activate a watch icon 1008 and a record icon 1010 by performing a single tap on touchscreen display 410 or touchscreen 502. Further, as illustrated in FIG. 10A and FIG. 10B, information window 1002 includes an exit icon 1012, which upon activation may cause information window 1002 to close.

It should be noted that although the example information windows illustrated in FIG. 10A and FIG. 10B do not include an image associated an item of content in other examples information window 1002 may include an image similar to image 904 described above with respect to FIG. 9. Further, it should be noted that in other examples information associated with an item of content may simply be displayed as either a scrolling name for an event (e.g., “Thor: The Dark World”) or a logo for the event, if available. In this manner, presenting an icon of content representing an item of content based on user preference information and enabling a user to perform one of a plurality of types of activations on the icons enables a user to obtain additional information associated with the item of contents and further enables a user, upon receiving additional information, to efficiently cause one or more actions associated with an item of content to be performed.

Referring again to FIG. 8, upon determining that an action drag and drop activation of an icon representing an item of content occurs, a companion device may cause an associated action to be performed (816). As described above, icons representing actions may be displayed on touchscreen display of a user interface. In the examples illustrated with respect to FIGS. 6A-7B, there are three types of action icons, record icon 604A, like icon 604, and share icon 604C. It should be noted that in other examples, other action icons may be displayed on a touchscreen of a user interface, for example, one or more of: an add an item of content to a watch list for viewing at a later time action, and/or a rate an item of content action. Further, in some examples a user may select which actions from a set of available action icons are presented on a user interface. It should be noted that in some examples, action icons may include complex actions, where a complex action may be defined as an action that would require a user to access multiple graphical user interfaces and/or executing multiple actions. Thus, in some examples action icons may provide a user with a more efficient way of performing actions. In this manner, action icons may provide a user with shortcuts.

Referring again to the examples illustrated in FIG. 6A-7B, recording icon 604A, when dropped on an icon representing an item of content may cause content associated with the item of content (e.g., a television program airing on a television channel) to be stored on a storage device. It should be noted that in some examples, causing content associated with the item of content to be stored on a storage device may be similar to causing content to be stored on a storage by activating record icon 910 and/or record icon 1010 described above. However, in other examples, distinct graphical user interfaces, including no graphical user interfaces, may respectively be presented based on activation of record icon 604A, record icon 910, and record icon 1010. That is, for example, intermediate graphical user interfaces used to confirm a recording may be presented upon activation of record icon 910 and/or record icon 1010 and not upon activation of record icon 604A.

FIG. 11A illustrates an example of a graphical user interface that may be presented on a companion device when record icon 604A is dropped on icon 602A illustrated in FIG. 6A. As illustrated in FIG. 11A, icon 602A is larger in FIG. 11A compared to FIG. 6A and a recording indicator icon is presented within the enlarged icon. In other examples, in addition to or as an alternative to enlarging an icon, another type of visual transformation of the icon may occur (e.g., a color change). In this manner, a user may have a visual indication on interface 400 that an event on HBO is being recorded. That is, a companion device may be configured to provide a visual indication that an action is in progress. When an action is completed (e.g., recording of a television event is completed) an icon may revert to its normal appearance.

It should be noted that in some examples, in addition to being associated with actions, enlarged icons may also, or alternatively, be associated with reminders. For example, if a television program a user has previously accessed is available on a television channel associated with an icon, the icon may be enlarged (e.g., NBC icon is enlarged when a new episode of the Voice is available). Further, it should be noted that in some cases an action may be incompatible with an item of content. For example, when an item of content includes an application (e.g., a game), a recording action may be incompatible with the item of content. In one example, a user interface may be configured to provide a user with an indication that a user is attempting to perform an incompatible action. For example, a user interface may provide an audible alert, a visual indication (e.g., icon turns red), and/or haptic feedback indicating to the user that the action is incompatible with the item of content.

As described above, a social media site may enable a user to endorse a particular item of content Like icon 604B, when dropped on an icon representing an item of content may cause a user to endorse a particular item of content. That is, like icon 604B may cause a user's profile page to be updated with an endorsement for a particular item of content. In one example, like icon 604B may be associated with the Facebook social media service. Like icon 604B may be particularly useful when an item of content includes a movie or an event (e.g., a live sporting event). It should be noted, that in some examples a companion device may cause a computing device to update a user's profile page by communicating with a social media site, e.g., social media site 124. In other examples, wherein a companion device is configured to communicate using a wide area network, a companion may update a user's profile page by communicating with a social media site.

As described above, a social media site may enable a user to share a particular item of content. Share icon 604C, when dropped on an icon representing an item of content may cause a user to share a particular item of content. That is, share icon 604C may cause a social media site to send a message including a reference to a particular item of content. In one example, share icon 604C may be associated with the Twitter social media service. Share icon 604C may be particularly useful when an item of content includes a movie or an event (e.g., a live sporting event). It should be noted, that in some examples a companion device may cause a computing device to communicate with a social media site, e.g., social media site 124. In other examples, wherein a companion device is configured to communicate using a wide area network, a companion may communicate with a social media site.

FIG. 11B illustrates an example of a graphical user interface that may be presented on a companion device when share icon 604C is dropped on icon 602C illustrated in 7B. As illustrated in FIG. 11B, touchscreen display 502 presents content sharing window 1102, where content sharing window 1102 includes a message including a reference to a particular item of content and send icon 1104 (“tweet” in the example illustrated in FIG. 11B), which upon activation may cause the message to be sent. It should be noted that in some examples content sharing window may include a link or information (e.g., a URL or a channel reference) that may enable another user to access the particular item of content referenced in the message. In this manner, presenting an icon of content representing an item of content based on user preference information and enabling a user to perform one of a plurality of types of activations on the icons enables a user to efficiently cause one or more actions associated with an item of content to be performed.

As described above, in some examples, a companion device may be associated with a plurality of computing devices. In this case, a user may wish to respectively control the presentation of content on each of the computing devices. FIG. 12 illustrates an example of a graphical user interface that includes action icons 604D-604F. In the example illustrated in FIG. 12, each of action icons 604D-604F are associated with a computing device. For example, action icon 604D may be associated with a set-top box located in a family room, action icon 604E may be associated with a television located in a bedroom, and action icon 604F may be associated with a television located in a kitchen. Upon a user dragging and dropping one of action icons 604D-604F on one of item of content icons 602A-602F, content associated with the item of content may be presented on the corresponding computing device. Thus, a companion device displaying the graphical user interface illustrated in FIG. 12 may enable a user to cause particular items of content to be presented on particular computing devices.

As described above, a companion device may be configured arrange the presentation of a plurality of icons representing items of content based on a likelihood of selection by the user. Referring again to FIG. 8, at 820, a companion device may determine whether at status change occurs. That is, a companion device may determine, for example, whether a different user logs-in to a computing device, a time period ends (e.g., a transition from a 7:30 PM time slot to an 8:00 PM), or a new item of content becomes available. As illustrated in FIG. 8, upon determining that a status change occurs, icons based on user preference information are presented at 802. That is, for example, icons may be rearranged and/or replaced on a touchscreen display. In this manner, a computing device may be configured to dynamically present available items of content to a user.

In one example, a method of causing actions associated with items of content to occur, comprises presenting at least one icon representing an item of content on a user interface of a companion device based at least in part on user preference information, wherein the user interface includes a touchscreen display, determining whether a particular type of icon activation from a set of at least two types of icon activations is performed on one of the icons presented on the user interface, and causing an action associated with an item of content to occur based on a determination that a particular type of activation was performed. In one example, user preference information includes a list of favorite television channels. In one example, user preference information is based at least in part on a recognized pattern of user behavior. In one example, presenting at least one icon based at least in part on user preference information includes presenting the at least one icon based on a likelihood of selection by a user. In one example, causing an action associated with an item of content to occur based on a determination that a particular type of activation was performed includes causing an item of content to be presented on a computing device other than the companion device based on a determination that a single tap activation was performed, and causing an informational window to be presented on a computing device other than the companion device based on a determination that a double tap activation was performed. In one example, causing an action associated with an item of content to occur based on a determination that a particular type of activation was performed includes causing an item of content to be presented on a computing device other than the companion device based on a determination that a single tap activation was performed, and causing an informational window to be presented on the companion device based on a determination that a long press activation was performed. In one example, the method further comprises presenting at least one action icon on the user interface of the companion device, wherein each action icon represents an action associated with an item of content, and causing an action associated with an action icon to occur based on a determination that an action icon drag and drop activation was performed. In one example actions associated with action icons include one or more of: a record an item of content action, an add an item of content to a watch list action, an endorse an item of content action, a share an item of content action, and rate an item of content action.

In one example, a device for enabling actions associated with items of content to occur comprises a touchscreen display configured to present at least one icon representing an item of content, wherein the at least one icon is presented based at least in part on user preference information, and one or more processors configured to: determine whether a particular type of icon activation from a set of at least two types of icon activations is performed on a presented icon, and cause an action associated with an item of content to occur based on a determination that a particular type of activation was performed. In one example, user preference information includes a list of favorite television channels. In one example, wherein user preference information is based at least in part on a recognized pattern of user behavior. In one example, presenting at least one icon based at least in part on user preference information includes presenting the at least one icon based on a likelihood of selection by a user. In one example, causing an action associated with an item of content to occur based on a determination that a particular type of activation was performed includes causing an item of content to be presented on a computing device other than the companion device. In one example, causing an action associated with an item of content to occur based on a determination that a particular type of activation was performed includes causing an informational window to be presented. In one example, the touchscreen display is further configured to present at least two action icons, wherein each action icon represents an action associated with an item of content. In one example, actions associated with action icons include one or more of: a record an item of content action, an add an item of content to a watch list action, an endorse an item of content action, a share an item of content action, and rate an item of content action. In one example, the one or more processors are further configured to: cause an action associated with an action icon to be occur based on a determination that an action icon drag and drop activation was performed.

In one example, a non-transitory computer-readable storage medium comprises instructions stored thereon that upon execution cause one or more processors of a device to present at least one icon on a user interface based at least in part on user preference information, wherein each icon represents an item of content, and wherein user preference information is based at least in part on a recognized pattern of user behavior, present at least one action icon representing actions associated with items of content on the user interface, and cause an action represented by an action icon to occur. In one example, actions represented by action icons include one or more of: a record an item of content action, an add an item of content to a watch list action, an endorse an item of content action, a share an item of content action, and rate an item of content action.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, which is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a mark-up language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method of causing actions associated with items of content to occur, the method comprising:
presenting at least one icon representing an item of content on a touchscreen display of a companion device;
and
causing an action associated with an item of content to occur based on a determination that a particular type of activation was performed on one of the at least one icons, wherein a first particular type of activation causes an item of content to be presented on a computing device other than the companion device, a second particular type of activation causes an informational window corresponding to the item of content to be presented on the computing device, and a third particular type of activation causes an information window corresponding to the item of content to be presented on the companion device.

2. The method of claim 1, wherein at least one of the at least one icons is presented based on user preference information and user preference information includes a list of favorite television channels.

3. The method of claim 1, wherein at least one of the at least one icons is presented based on user preference information and user preference information is based at least in part on a recognized pattern of user behavior.

4. The method of claim 1, wherein at least one of the at least one icons is presented based on user preference information and user preference information includes a likelihood of selection by a user.

5-7. (canceled)

8. The method of claim 1, further comprising:
presenting at least one action icon on the user interface of the companion device, wherein each action icon represents an action associated with an item of content; and
causing an action associated with an action icon to occur based on a determination that an action icon drag and drop activation was performed.

9. The method of claim 8, wherein actions associated with action icons include one or more of: a record an item of content action, an add an item of content to a watch list action, an endorse an item of content action, a share an item of content action, and rate an item of content action.

10. A device for enabling actions associated with items of content to occur, the device comprising:
a touchscreen display presenting at least one icon representing respective items of content; and
one or more processors:
causing an action associated with an item of content to occur based on a determination that a particular type of activation was performed on one of the at least one icons, wherein a first particular type of activation causes an item of content to be presented on a computing device other than the companion device, a second particular type of activation causes an informational window corresponding to the item of content to be presented on the computing device, and a third particular type of activation causes an information window corresponding to the item of content to be presented on the companion device.

11. The device of claim 10, wherein at least one of the at least one icons is presented based on user preference information and user preference information includes a list of favorite television channels.

12. The device of claim 10, wherein at least one of the at least one icons is presented based on user preference information and user preference information is based at least in part on a recognized pattern of user behavior.

13. The device of claim 10, wherein at least one of the at least one icons is presented based on user preference information and user preference information includes a likelihood of selection by a user.

14-15. (canceled)

16. The device of claim 10, wherein the touchscreen display further presents at least two action icons, wherein each action icon represents an action associated with an item of content.

17. The device of claim 16, wherein actions associated with action icons include one or more of: a record an item of content action, an add an item of content to a watch list action, an endorse an item of content action, a share an item of content action, and rate an item of content action.

18. The device of claim 17, wherein the one or more processors further
cause an action associated with an action icon to be occur based on a determination that an action icon drag and drop activation was performed.

19. A non-transitory computer-readable storage medium comprising instructions stored thereon that upon execution cause one or more processors of a device to:
present at least one icon on a user interface based at least in part on user preference information, wherein each icon represents an item of content, and wherein user preference information is based at least in part on a recognized pattern of user behavior;
cause an action associated with an item of content to occur based on a determination that a particular type of activation was performed on one of the at least one icons, wherein a first particular type of activation causes an item of content to be presented on a computing device other than the companion device, a second particular type of activation causes an informational window corresponding to the item of content to be presented on the computing device, and a third particular type of activation causes an information window corresponding to the item of content to be presented on the companion device;
present a record action icon on the user interface; and
cause an item of content to be stored to a storage device upon the record icon being dragged and dropped on an icon representing an item of content.

20. (canceled)

21. The method of claim 8, wherein the at least one action icon includes a record icon and the action associated with the record icon includes causing an item of content to be stored to a storage device.

22. The method of claim 21, wherein the particular types of activations include a single tap activation, a double-tap activation, and a long press activation.

23. The device of claim 10, wherein the touchscreen display further presents a record icon and an item of content is stored to a storage device upon the record icon being dragged and dropped on an icon representing an item of content.

24. The device of claim 23, wherein the particular types of activations include a single tap activation, a double-tap activation, and a long press activation.

25. The non-transitory computer-readable storage medium of claim 19, wherein the particular types of activations include a single tap activation, a double-tap activation, and a long press activation.

26. The non-transitory computer-readable storage medium of claim 25, wherein the first particular type of activation is a single tap activation, the second particular type of activation is a double-tap activation, and the third particular type of activation is a long press activation.
